(19) United States
(12) Patent Application Publication
(10) Pub. No.: US 2024/0235622 A1
(43) Pub. Date: Jul. 11, 2024

(54) TECHNIQUES FOR PASSIVE COMMUNICATION OF A REFLECTIVE SURFACE WITH A BASE STATION

(71) Applicant: QUALCOMM Incorporated, San Diego, CA (US)

(72) Inventors: Saeid SAHRAEI, San Diego, CA (US); Ahmed ELSHAFIE, San Diego, CA (US); Yu ZHANG, San Diego, CA (US); Hung Dinh LY, San Diego, CA (US); Krishna Kiran MUKKAVILLI, San Diego, CA (US)

(21) Appl. No.: 18/558,715

(22) PCT Filed: Jul. 12, 2021
(86) PCT No.: PCT/CN2021/105678

§ 371 Date: Nov. 2, 2023

(51) Int. Cl. H04B 7/04; H04B 7/026

(52) U.S. Cl. CPC H04B 7/04013; H04B 7/026

(57) ABSTRACT

Methods, systems, and devices for wireless communications are described. A reconfigurable reflective surface may exploit signals transmitted from a user equipment (UE) to communicate feedback to a base station. For example, the surface may communicate feedback by reflecting two or more reference signals according to two or more configurations. In some cases, the two or more configurations may be phase shifted relative each other. In another example, the surface may communicate feedback by altering the intensity of or more reference signals transmitted from the UE. In yet another example, the surface may communicate feedback to the base station by reflecting reference signals towards one or more antenna arrays. In some cases, the one or more antenna arrays may be located at a single base station. In some other cases, the one or more antenna arrays may be located at multiple base stations or multiple transmission/reception points.

### CROSS REFERENCE

The present Application is a 371 national stage filing of International PCT Application No. PCT/CN2021/105678 by SAHRAEI et al. entitled “TECHNIQUES FOR PASSIVE COMMUNICATION OF A REFLECTIVE SURFACE WITH A BASE STATION,” filed Jul. 12, 2021, which is assigned to the assignee hereof, and which is expressly incorporated by reference in its entirety herein.

### FIELD OF TECHNOLOGY

The following relates to wireless communications, including techniques for passive communication of a reflective surface with a base station.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some cases, a base station may communicate with a UE via a reconfigurable reflective surface to extend a wireless coverage area. In some cases, existing techniques for communication via a reconfigurable reflective surface may be deficient.

### SUMMARY

The described techniques relate to improved methods, systems, devices, and apparatuses that support techniques for passive communication of a reflective surface with a base station. Generally, a base station may communicate with a user equipment (UE) via one or more reconfigurable reflective surfaces. For example, a reconfigurable reflective surface may monitor for a control message from a base station and then, based on the monitoring, determine feedback. In some examples, the reconfigurable reflective surface may identify a first and a second set of phase parameters which may be used to reflect communications between a UE and the base station. In some cases, the reconfigurable reflective surface may apply the first and the second set of phase parameters to multiplex the feedback on at least one signal from the UE reflected to the base station via the reconfigurable reflective surface. In some cases, the base station may receive the at least one signal reflected to the base station by the reconfigurable reflective surface. In some cases, the at least one signal may indicate that the reconfigurable reflective surface applied at least one of the first set or the second set of phase parameters for reflecting the at least one signal. In some cases, the base station may determine feedback by the reconfigurable reflective surface for the control message based on the at least one signal being reflected at the reconfigurable reflective surface using at least one of the first set or the second set of phase parameters.

A method for wireless communications at a reconfigurable reflective surface is described. The method may include monitoring for a control message, from a base station, directed to the reconfigurable reflective surface, determining feedback based on monitoring for the control message, identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a user equipment (UE) and the base station, and applying the first set of phase parameters and the second set of phase parameters to multiplex the feedback on at least one signal from the UE reflected to the base station via the reconfigurable reflective surface.

An apparatus for wireless communications at a reconfigurable reflective surface is described. The apparatus may include a processor, memory coupled with the processor, and instructions stored in the memory. The instructions may be executable by the processor to cause the apparatus to monitor for a control message, from a base station, directed to the reconfigurable reflective surface, determine feedback based on monitoring for the control message, identify a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station, and apply the first set of phase parameters and the second set of phase parameters to multiplex the feedback on at least one signal from the UE reflected to the base station via the reconfigurable reflective surface.

Another apparatus for wireless communications at a reconfigurable reflective surface is described. The apparatus may include means for monitoring for a control message, from a base station, directed to the reconfigurable reflective surface, means for determining feedback based on monitoring for the control message, means for identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station, and means for applying the first set of phase parameters and the second set of phase parameters to multiplex the feedback on at least one signal from the UE reflected to the base station via the reconfigurable reflective surface.

A non-transitory computer-readable medium storing code for wireless communications at a reconfigurable reflective surface is described. The code may include instructions executable by a processor to monitor for a control message, from a base station, directed to the reconfigurable reflective surface, determine feedback based on monitoring for the control message, identify a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station, and apply the first set of phase parameters and the second set of phase parameters to multiplex the feedback on at least one signal from the UE reflected to the base station via the reconfigurable reflective surface.

In some examples of the method, apparatuses, and non-transitory computer-readable medium described herein, identifying the first set of phase parameters for the reconfigurable reflective surface and the second set of phase parameters for the reconfigurable reflective surface may include operations, features, means, or instructions for identifying a first configuration matrix for a first one or more reflective components at the reconfigurable reflective surface and identifying a second configuration matrix for a second one or more reflective components at the reconfigurable reflective surface, where values of the second configuration matrix may have opposite signs as values of the first configuration matrix.

Some examples of the method, apparatuses, and non-transitory computer-readable medium described herein may further include operations, features, means, or instructions for multiplexing the feedback onto a combination of a first signal and a second signal from the UE by reflecting the first signal using the first set of phase parameters in accordance with the first configuration matrix and reflecting the second signal using the second set of phase parameters in accordance with the second configuration matrix, where the at least one signal includes the first signal and the second signal.

Some examples of the method, apparatuses, and non-transitory computer-readable medium described herein may further include operations, features, means, or instructions for multiplexing the feedback onto a combination of a first signal and a second signal from the UE by reflecting the first signal using the first set of phase parameters in accordance with the first configuration matrix and reflecting the second signal using the second set of phase parameters in accordance with the first configuration matrix, where the at least one signal includes the first signal and the second signal.

In some examples of the method, apparatuses, and non-transitory computer-readable medium described herein, identifying the first set of phase parameters for the reconfigurable reflective surface and the second set of phase parameters for the reconfigurable reflective surface may include operations, features, means, or instructions for identifying a first configuration matrix for a first one or more reflective components at the reconfigurable reflective surface and identifying a second configuration matrix for a second one or more reflective components at the reconfigurable reflective surface, where values of the second configuration matrix weaken signal reception at the base station with respect to values of the first configuration matrix.

Some examples of the method, apparatuses, and non-transitory computer-readable medium described herein may further include operations, features, means, or instructions for multiplexing the feedback onto a first signal from the UE, a second signal from the UE, or both, by reflecting the first signal using the first set of phase parameters in accordance with the first configuration matrix, reflecting the second signal using the second set of phase parameters in accordance with the second configuration matrix, or both, where the at least one signal includes the first signal, the second signal, or both.

In some examples of the method, apparatuses, and non-transitory computer-readable medium described herein, the values of the second configuration matrix may be orthogonal to the values of the first configuration matrix.

In some examples of the method, apparatuses, and non-transitory computer-readable medium described herein, the values of the second configuration matrix scatter a second signal with respect to application of the values of the first configuration matrix to a first signal.

In some examples of the method, apparatuses, and non-transitory computer-readable medium described herein, the values of the second configuration matrix produce a wider beam than the values of the first configuration matrix.

In some examples of the method, apparatuses, and non-transitory computer-readable medium described herein, applying the first set of phase parameters and the second set of phase parameters may include operations, features, means, or instructions for deactivating the second one or more reflective components, where the signal reception at the base station may be weakened based on deactivating the second one or more reflective components.

In some examples of the method, apparatuses, and non-transitory computer-readable medium described herein, identifying the first set of phase parameters for the reconfigurable reflective surface and the second set of phase parameters for the reconfigurable reflective surface may include operations, features, means, or instructions for identifying a first configuration matrix for a first one or more reflective components at the reconfigurable reflective surface and identifying a second configuration matrix for a second one or more reflective components at the reconfigurable reflective surface, where values of the first configuration matrix and the second configuration matrix may be based on a code division multiple access (CDMA) pattern associated with a first antenna panel and a second antenna panel at the base station.

Some examples of the method, apparatuses, and non-transitory computer-readable medium described herein may further include operations, features, means, or instructions for multiplexing the feedback onto the at least one signal from the UE by reflecting the at least one signal to the first antenna panel using the first set of phase parameters in accordance with the first configuration matrix and reflecting the at least one signal to the second antenna panel using the second set of phase parameters in accordance with the second configuration matrix, where the CDMA pattern includes a first energy level associated with reception of the at least one signal at the first antenna panel and a second energy level associated with reception of the at least one signal at the second antenna panel.

Some examples of the method, apparatuses, and non-transitory computer-readable medium described herein may further include operations, features, means, or instructions for receiving the control message based on the monitoring for the control message, where the feedback includes an acknowledgement message based on the receiving the control message.

In some examples of the method, apparatuses, and non-transitory computer-readable medium described herein, applying the first set of phase parameters and the second set of phase parameters may include operations, features, means, or instructions for applying a first configuration matrix for a first one or more reflective components at the reconfigurable reflective surface to reflect a first signal from the UE to the base station in accordance with the first set of phase parameters and applying a second configuration matrix for a second one or more reflective components at the reconfigurable reflective surface to reflect a second signal from the UE to the base station in accordance with the second set of phase parameters, where the at least one signal includes both the first signal and the second signal.

In some examples of the method, apparatuses, and non-transitory computer-readable medium described herein, the first signal may be received from the UE in a first symbol, and the second signal may be received from the UE in a second symbol.

In some examples of the method, apparatuses, and non-transitory computer-readable medium described herein, the first symbol and the second symbol may be separated by a time gap.

Some examples of the method, apparatuses, and non-transitory computer-readable medium described herein may further include operations, features, means, or instructions for receiving control signaling indicating a size of a time gap between the first symbol and the second symbol, where applying the first set of phase parameters and the second set of phase parameters may be based on receiving the control signaling.

In some examples of the method, apparatuses, and non-transitory computer-readable medium described herein, the first signal includes a first repetition of an uplink control channel, and the second signal includes a second repetition of the uplink control channel.

In some examples of the method, apparatuses, and non-transitory computer-readable medium described herein, the first set of phase parameters indicates a first bit of a bit sequence, the second set of phase parameters indicates a second bit of the bit sequence, and the feedback includes the bit sequence.

In some examples of the method, apparatuses, and non-transitory computer-readable medium described herein, the at least one signal carries one or more feedback bits from the UE.

A method for wireless communications at a base station is described. The method may include transmitting a control message directed to a reconfigurable reflective surface, receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal, and determining a feedback by the reconfigurable reflective surface for the control message based on the at least one signal being reflected at the reconfigurable reflective surface using at least one of the first set of phase parameters or the second set of phase parameters.

An apparatus for wireless communications at a base station is described. The apparatus may include a processor, memory coupled with the processor, and instructions stored in the memory. The instructions may be executable by the processor to cause the apparatus to transmit a control message directed to a reconfigurable reflective surface, receive at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal, and determine a feedback by the reconfigurable reflective surface for the control message based on the at least one signal being reflected at the reconfigurable reflective surface using at least one of the first set of phase parameters or the second set of phase parameters.

Another apparatus for wireless communications at a base station is described. The apparatus may include means for transmitting a control message directed to a reconfigurable reflective surface, means for receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal, and means for determining a feedback by the reconfigurable reflective surface for the control message based on the at least one signal being reflected at the reconfigurable reflective surface using at least one of the first set of phase parameters or the second set of phase parameters.

A non-transitory computer-readable medium storing code for wireless communications at a base station is described. The code may include instructions executable by a processor to transmit a control message directed to a reconfigurable reflective surface, receive at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal, and determine a feedback by the reconfigurable reflective surface for the control message based on the at least one signal being reflected at the reconfigurable reflective surface using at least one of the first set of phase parameters or the second set of phase parameters.

In some examples of the method, apparatuses, and non-transitory computer-readable medium described herein, receiving the at least one signal reflected to the base station by the reconfigurable reflective surface from the UE may include operations, features, means, or instructions for receiving a first signal indicative of the first set of phase parameters applied at the reconfigurable reflective surface for reflecting the first signal and receiving a second signal indicative of the second set of phase parameters applied at the reconfigurable reflective surface for reflecting the second signal, where a first channel estimate for the first signal and a second channel estimate for the second signal indicate the feedback for the reconfigurable reflective surface for the control message.

In some examples of the method, apparatuses, and non-transitory computer-readable medium described herein, determining the feedback by the reconfigurable reflective surface for the control message may include operations, features, means, or instructions for determining the feedback by identifying that a first value of the first channel estimate may have an opposite sign as a second value of the second channel estimate, where the at least one signal includes the first signal and the second signal.

In some examples of the method, apparatuses, and non-transitory computer-readable medium described herein, determining the feedback by the reconfigurable reflective surface for the control message may include operations, features, means, or instructions for determining the feedback by identifying that a first value of the first channel estimate may have a same sign as a second value of the second channel estimate.

In some examples of the method, apparatuses, and non-transitory computer-readable medium described herein, receiving the at least one signal reflected to the base station by the reconfigurable reflective surface from the UE may include operations, features, means, or instructions for receiving a first signal indicative of the first set of phase parameters applied at the reconfigurable reflective surface for reflecting the first signal, a second signal indicative of the second set of phase parameters applied at the reconfigurable reflective surface for reflecting the second signal, or both, where the at least one signal includes the first signal, the second signal, or both.

In some examples of the method, apparatuses, and non-transitory computer-readable medium described herein, a first signal strength for the first signal, a second signal strength for the second signal, or both, indicate the feedback for the reconfigurable reflective surface for the control message.

In some examples of the method, apparatuses, and non-transitory computer-readable medium described herein, a first beam width of the first signal, a second beam width of the second signal, or both, indicate the feedback for the reconfigurable reflective surface for the control message.

In some examples of the method, apparatuses, and non-transitory computer-readable medium described herein, receiving the at least one signal reflected to the base station by the reconfigurable reflective surface from the UE may include operations, features, means, or instructions for receiving the at least one signal at a first antenna panel at the base station, the at least one signal at the first antenna panel indicative of the first set of phase parameters applied at the reconfigurable reflective surface for reflecting the at least one signal and receiving the at least one signal at a second antenna panel at the base station, the at least one signal at the second antenna panel indicative of the second set of phase parameters applied at the reconfigurable reflective surface for reflecting the at least one signal, where a code division multiple access (CDMA) pattern associated with reception of the at least one signal at the first antenna panel and reception of the at least one signal at the second antenna panel at the base station indicates the feedback for the reconfigurable reflective surface for the control message.

In some examples of the method, apparatuses, and non-transitory computer-readable medium described herein, the CDMA pattern includes a first energy level associated with the reception of the at least one signal at the first antenna panel and a second energy level associated with the reception of the at least one signal at the second antenna panel.

In some examples of the method, apparatuses, and non-transitory computer-readable medium described herein, the feedback includes an acknowledgement message indicating reception of the control message at the reconfigurable reflective surface.

In some examples of the method, apparatuses, and non-transitory computer-readable medium described herein, receiving the at least one signal reflected to the base station by the reconfigurable reflective surface from the UE may include operations, features, means, or instructions for receiving a first signal indicative of the first set of phase parameters applied at the reconfigurable reflective surface for reflecting the first signal and receiving a second signal indicative of the second set of phase parameters applied at the reconfigurable reflective surface for reflecting the second signal, where the at least one signal includes the first signal and the second signal.

In some examples of the method, apparatuses, and non-transitory computer-readable medium described herein, the first signal may be received in a first symbol, and the second signal may be received in a second symbol.

In some examples of the method, apparatuses, and non-transitory computer-readable medium described herein, the first symbol and the second symbol may be separated by a time gap.

Some examples of the method, apparatuses, and non-transitory computer-readable medium described herein may further include operations, features, means, or instructions for transmitting control signaling indicating a size of a time gap between the first symbol and the second symbol, where the receiving the first signal and the second signal may be based on the transmitting the control signaling.

In some examples of the method, apparatuses, and non-transitory computer-readable medium described herein, the first signal includes a first repetition of an uplink control channel, and the second signal includes a second repetition of the uplink control channel.

In some examples of the method, apparatuses, and non-transitory computer-readable medium described herein, the first set of phase parameters indicates a first bit of a bit sequence, the second set of phase parameters indicates a second bit of the bit sequence, and the feedback includes the bit sequence.

In some examples of the method, apparatuses, and non-transitory computer-readable medium described herein, the at least one signal carries one or more feedback bits from the UE.

### BRIEF DESCRIPTION OF THE DRAWINGS

FIGS. 1 through 3, 4A, 4B, 5A, 5B, and 6 illustrate examples of wireless communications systems that support techniques for passive communication of a reflective surface with a base station in accordance with aspects of the present disclosure.

FIGS. 7A & 7B illustrate examples of timing diagrams that support techniques for passive communication of a reflective surface with a base station in accordance with aspects of the present disclosure.

FIG. 8 illustrates an example of a process flow that supports techniques for passive communication of a reflective surface with a base station in accordance with aspects of the present disclosure.

FIGS. 9 and 10 show block diagrams of devices that support techniques for passive communication of a reflective surface with a base station in accordance with aspects of the present disclosure.

FIG. 11 shows a block diagram of a communications manager that supports techniques for passive communication of a reflective surface with a base station in accordance with aspects of the present disclosure.

FIG. 12 shows a diagram of a system including a device that supports techniques for passive communication of a reflective surface with a base station in accordance with aspects of the present disclosure.

FIGS. 13 and 14 show block diagrams of devices that support techniques for passive communication of a reflective surface with a base station in accordance with aspects of the present disclosure.

FIG. 15 shows a block diagram of a communications manager that supports techniques for passive communication of a reflective surface with a base station in accordance with aspects of the present disclosure.

FIG. 16 shows a diagram of a system including a device that supports techniques for passive communication of a reflective surface with a base station in accordance with aspects of the present disclosure.

FIGS. 17 through 20 show flowcharts illustrating methods that support techniques for passive communication of a reflective surface with a base station in accordance with aspects of the present disclosure.

### DETAILED DESCRIPTION

Wireless communications systems may be configured to support multiple-input, multiple-output (MIMO) communications at various frequency bands to enable increased throughput within the wireless communications systems. The devices (e.g., user equipments (UEs) and base stations) of the wireless communications system may support beamforming in order to improve signal reliability and efficiency for MIMO communications. In some cases, a beamformed link between a UE and a base station may be impacted by external factors, such as a physical blocking object, signal fading, or other phenomena. To support communications in the presence of such external factors, the wireless communications system may use additional wireless nodes that may be configured to route communications such that the external factors are limited or avoided.

In some examples, wireless nodes may be active or mostly passive (e.g., near passive) devices. Example active devices may include active antenna units (AAUs) or wireless repeaters, and such devices may include active antennas and the supporting radio frequency circuitry. Active devices may receive a signal from a transmitting device (e.g., a UE or a base station) and actively retransmit the signal to a receiving device (e.g., a UE or a base station). However, given the active nature of such devices, AAUs and wireless repeaters may utilize significant power. Example passive devices may include reconfigurable reflective surfaces, which may also be referred to as reconfigurable intelligent surfaces (RISs), channel engineering devices (CEDs), or configurable deflectors. Although a RIS is referred to throughout the disclosure, it should be understood that the techniques described herein may also apply to other reconfigurable reflective surfaces. A RIS may act as a near passive device that reflects an impinging wave into a desired direction. For example, a RIS may include a set of elements which may be used to receive a signal from a transmitting device (e.g., a UE or base station) and reflect the signal towards a receiving device (e.g., another UE or base station) according to a configuration. Stated alternatively, a RIS may use configured phase information to reflect impinging waves in a desired direction. Given the near passive nature of such devices, reconfigurable reflective surfaces may utilize significantly less power than active devices. As such, a wireless communications system may employ a RIS to extend communications coverage around, or because of, blockages with negligible power consumption costs.

In some cases, the direction in which a RIS reflects an impinging wave may be controlled (e.g., configured) by a base station. For example, a base station may transmit control signaling to indicate a configuration (e.g., a reflective phase configuration) to the RIS. In some cases, the configuration may include phase information for each element included in the RIS. The reconfigurable reflective surface may then use the configuration to reflect signals transmitted from the base station towards a target UE and, similarly, reflect signals transmitted from the target UE towards the base station. In some examples, it may be desirable for a RIS to transfer (e.g., communicate) one or more bits of information to a base station. For example, it may be desirable for a RIS to communicate feedback to a base station in response to receiving control signaling (e.g., radio resource control (RRC) signaling) from the base station. In some other examples, it may be desirable for a RIS to communicate channel quality information (e.g., for a channel between the UE and the RIS, or for a channel between the RIS and a base station, or both) to the base station. In yet another example, it may be desirable for a RIS to communicate information regarding the status (e.g., presence) of the RIS in the network. However, a RIS may be near passive (e.g., may not include power amplifiers) and therefore may not have direct transmission capability.

According to the techniques described herein, a RIS may exploit signals (e.g., reference signals) transmitted from a UE to communicate one or more bits of information (e.g., feedback, channel quality information, or network status information) to a base station. For example, the RIS may communicate feedback by reflecting two or more reference signals according to two or more configurations. In some cases, the two or more configurations may be phase shifted relative each other. In another example, a RIS may communicate feedback by altering the intensity of or more reference signals transmitted from the UE. In yet another example, a RIS may communicate feedback to a base station by reflecting reference signals towards one or more antenna arrays. In some cases, the one or more antenna arrays may be located at a single base station. In some other cases, the one or more antenna arrays may be located at multiple base stations or multiple transmission/reception points (TRPs).

One or more aspects of the disclosure are initially described in the context of wireless communications systems. Example timing diagrams and an example process flow illustrating one or more aspects of the discussed techniques are then described. Aspects of the disclosure are further illustrated by and described with reference to apparatus diagrams, system diagrams, and flowcharts that relate to communication of one or more RISs with a base station.

Aspects of the disclosure are initially described in the context of wireless communications systems. One or more aspects of the disclosure are further illustrated by and described with reference to timing diagrams, a process flow, apparatus diagrams, system diagrams, and flowcharts that relate to techniques for passive communication of a reflective surface with a base station.

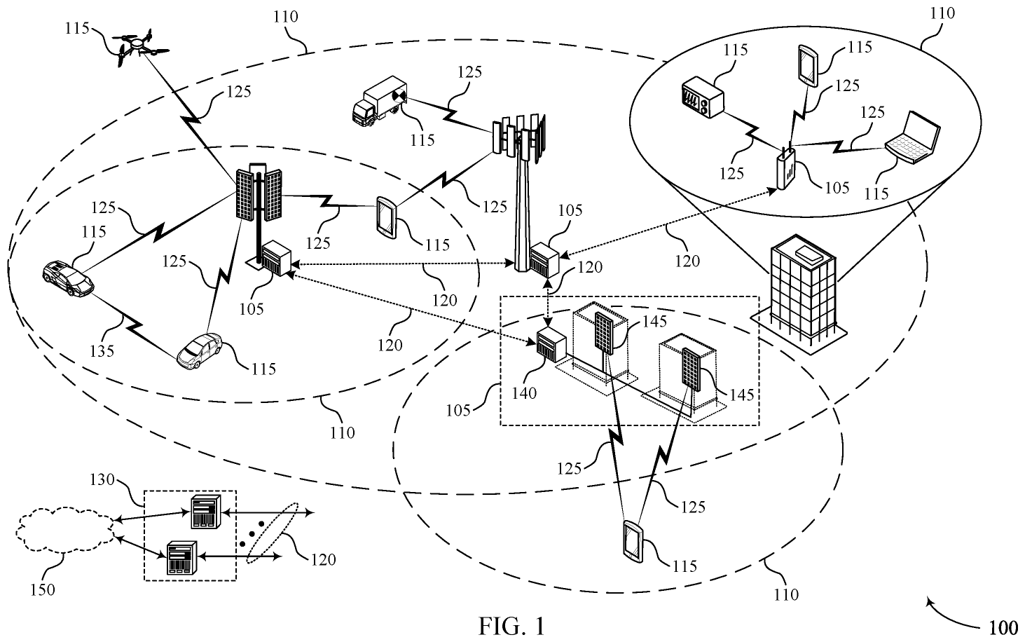

FIG. 1 illustrates an example of a wireless communications system 100 that supports techniques for passive communication of a reflective surface with a base station in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfmax·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or TRPs. Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, MIMO communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the wireless communications system 100 may support one or more aspects of the techniques for passive communication between a base station 105 and a UE 115 via one or more RISs (not shown). For example, a RIS may monitor for a control message from a base station 105 and then, based on the monitoring, determine feedback. In some examples, the RIS may identify a first and a second set of phase parameters which may be used to reflect communications between a UE 115 and the base station 105. In some cases, the RIS may apply the first and the second set of phase parameters to multiplex the feedback on at least one signal from the UE 115 reflected to the base station 105 via the RIS. In some cases, the base station 105 may receive the at least one signal which may indicate that the RIS applied at least one of the first set or the second set of phase parameters for reflecting the at least one signal. In some cases, the base station 105 may determine feedback by the RIS for the control message based on the at least one signal being reflected at the RIS using at least one of the first set or the second set of phase parameters.

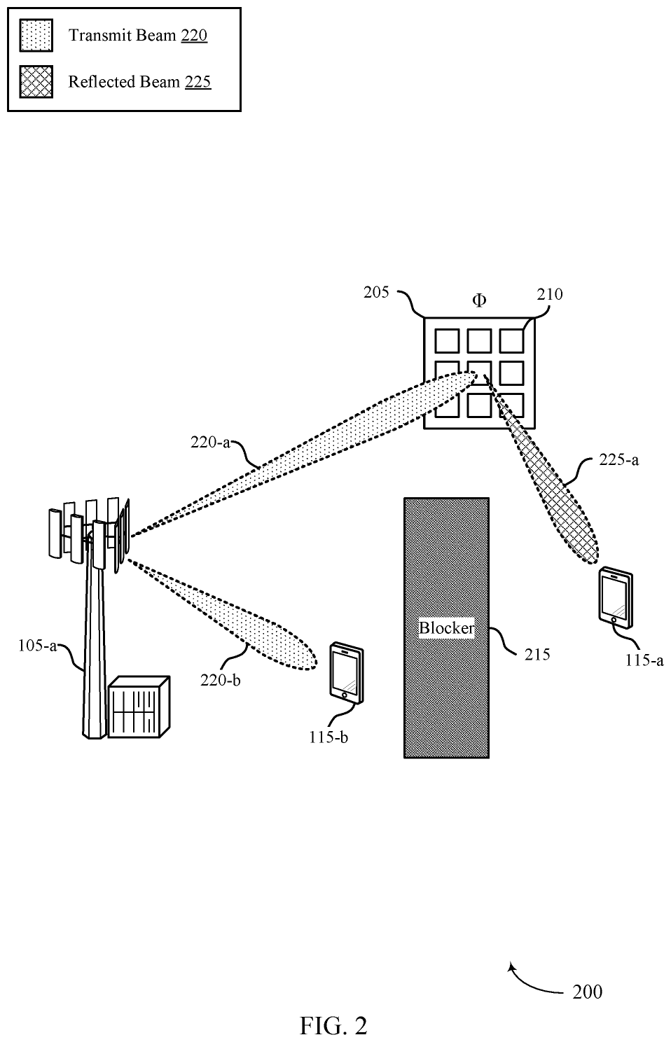

FIG. 2 illustrates an example of a wireless communications system 200 that supports techniques for passive communication of a reflective surface with a base station in accordance with aspects of the present disclosure. In some examples, wireless communications systems 200 may implement aspects of wireless communications system 100. For instance, the wireless communications system 200 may include a base station 105 and one or more UEs 115, which may be examples of the corresponding devices described with reference to FIG. 1. The wireless communications system 200 may include features for improved communications between the UEs 115 and the base station 105, among other benefits.

The wireless communications system 200 illustrates communications between the base station 105-a and a UE 115-a in the presence of a blocker 215. The wireless communications system 200 also illustrates communications between the base station 105-a and a UE 115-b in the absence of the blocker 215. In the absence of the blocker 215, a base station 105-a may directly transmit signals to the UE 115-b via a transmit beam 220-b. However, because the direct path between the UE 115-a and the base station 105-a is obstructed by the blocker 215, the base station 105-a may be unable to directly transmit signals to the UE 115-a. The blocker 215 may represent a physical obstruction, signal fading, or any other phenomenon or combination of phenomena that may cause communications between the base station 105-a and the UE 115-a to experience signal loss or interference. In this example, the blocker 215 may be a physical obstruction (e.g., buildings, mountains, people, etc.) positioned such that direct communications between the UE 115-a and the base station 105-a may be impacted, such as by experiencing signal loss or interference. Signal loss or interference may be determined by the network, the UE 115-a, the base station 105-a, or any combination thereof. Additionally, it should be understood that the implementations described herein may be applicable with or without the blocker 215.

In some cases, to correct signal loss or to otherwise improve the efficiency or reliability of the wireless connection between the base station 105-a and the UE 115-a, the base station 105-a may utilize additional wireless nodes, such as a RIS 205, to extend coverage and enhance communications with the UE 115-a. For example, the base station 105-a may extend coverage and enhance communications with the UE 115-a through the use of active devices or near passive devices. In some examples, active or near passive devices may be used to achieve high beamforming gain. In some cases, a base station 105 may employ active or near passive devices for both uplink and downlink communications with the UE 115-a in order to circumvent the blocker 215 or for other communication enhancement purposes. An active unit, such as an AAU, may include individual radio frequency chains per antenna port and, as a result, may be associated with a significant increase in power consumption. In contrast, near passive units, such as the RIS 205, may be deployed in the wireless network to extend coverage with negligible power consumption. The RIS 205 may be referred to as a near passive device, for example, because the RIS 205 may not be configured with active antennas or associated radio frequency circuitry to support the antennas. Instead, the RIS 205 may include a set of reflective elements 210 (e.g., reconfigurable reflective components) which may be used to receive a signal from a transmitting device and reflect the signal towards a receiving device, according to a configuration. The configuration may include phase information for reflective elements 210 included in the RIS 205. In some instances, the configuration may be indicated by a base station 105 (e.g., via control signaling) to optimize the phase of the reflective elements 210 such that signals incident on the RIS 205 are directed toward the base station 105. In some examples, such a configuration may be referred to as an optimal configuration, phi, or Φ.

For example, a RIS 205 may monitor for a control message (e.g., including phase information) from a base station 105 and then, based on the monitoring, determine feedback. In some examples, the RIS 205 may identify a first and a second set of phase parameters which may be used to reflect communications (e.g., signals) between a UE 115 and the base station 105. In some cases, the RIS 205 may apply the first and the second set of phase parameters (e.g., using the reflective elements 210) to multiplex the feedback on at least one signal from the UE 115 reflected to the base station 105 via the RIS 205. In some cases, the base station 105 may receive the at least one signal which may indicate that the RIS 205 applied at least one of the first set or the second set of phase parameters for reflecting the at least one signal. In some cases, the base station 105 may determine feedback by the RIS 205 for the control message based on the at least one signal being reflected at the RIS 205 using at least one of the first set or the second set of phase parameters.

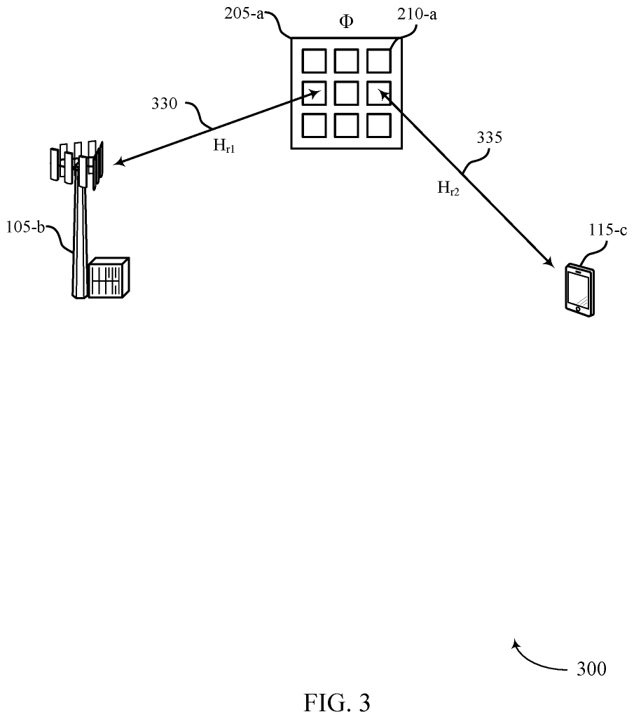

FIG. 3 illustrates an example of a wireless communications system 300 that supports techniques for passive communication of a reflective surface with a base station in accordance with aspects of the present disclosure. In some examples, wireless communications system 300 may implement or be implemented by one or more aspects of the wireless communications systems 100 and 200. For instance, the wireless communications system 300 may include a base station 105-b, a UE 115-c, and a RIS 205-a which may be examples of the corresponding devices described with reference to FIGS. 1 and 2. The wireless communications system 300 may include features for improved communications between the UE 115-c and the base station 105-b, among other benefits.

Wireless communications system 300 may include a RIS 205-a that includes a set of M reconfigurable reflective elements (e.g., components), including a reflective element 210-a. Each element of the RIS 205-a may be configured to redirect (e.g., reflect, refract, or diffract) communications from the UE 115-c to the base station 105-b and, similarly, from the base station 105-b to the UE 115-c. The direction of the reflected beam may be controllable by the base station 105-b. For example, the base station 105-b may transmit, to the RIS 205-a, control signaling (e.g., an RRC message) indicating a configuration (e.g., Φ) for the RIS 205-a. In some cases, Φ may be a reflection configuration matrix which may define a phase for reflective elements (e.g., including the reflective element 210-a) at the RIS 205-a. In some cases, Φ may be a diagonalized matrix. For instance, Φ may include a number of elements where the off diagonal elements are 0 and the diagonal elements define the relative phase for each RIS element involved in the reflection process (e.g., the elements involved in reflecting beams from the base station 105-b to the UE 115-c and, similarly, from the UE 115-c to the base station 105-b). In some cases, the number of elements involved in the reflecting process (e.g., the number of elements along the diagonal of Φ) may be less than or equal to M.

In some examples, the base station 105-b may communicate along a path including the path 330 and the path 335, where the matrix representation of the channel of path 330 (e.g., the channel between the base station 105-b and the RIS 205-a) is Hᵣ₁ and the matrix representation of the channel of path 335 (e.g., the path between the RIS 205-a and the UE 115-c) is Hᵣ₂. In some examples, the RIS 205-a may apply Φ to reflect a signal transmitted from the UE 115-c towards the base station 105-b. In some cases, the channel of the signal received by the base station 105-b may be an aggregate (e.g., concatenated) channel including channels Hᵣ₁ and Hᵣ₂. In such a case, the estimated channel may be represented as \tilde{H}≈Hᵣ₁ ΦHᵣ₂. In some cases, to optimize the configuration for the RIS 205-a, it may be beneficial for the base station 105-b to acquire information regarding the channels Hᵣ₁ and Hᵣ₂. The RIS 205-a may measure (e.g., individually) the channel quality of channel Hᵣ₁ and the channel quality of channel Hᵣ₂. Therefore, it may be beneficial for the RIS 205-a to communicate channel quality information for Hᵣ₁ and Hᵣ₂ directly to the base station 105-b. In some other cases, the base station 105-b may transmit control signaling (e.g., an RRC message) indicating a configuration for a RIS 205-a. In such a case it may be beneficial for the RIS 205-a to communicate positive feedback (e.g., a positive acknowledgement (ACK) message), negative feedback (e.g., a negative acknowledgement (NACK) message), or other feedback based on whether the control signaling was successfully received by the RIS 205-a.

In some examples, to communicate one or more bits of information (e.g., channel quality information or feedback) the RIS 205-a may exploit signals (e.g., reference signals) transmitted from the UE 115-c to the base station 105-b. For example, the configuration of reflective elements (e.g., a reflective element 210-a) in the RIS 205-a may be manipulated by the RIS 205-a and used to communicate information to the base station 105-b. For instance, if the UE 115-c is configured to transmit two reference signals in two symbols (e.g., two separate symbols) to the base station 105-b, the RIS may apply a first configuration (Φ₁) to reflect the first refence signal, and a second configuration (Φ₂) to reflect the second reference signal, where Φ₁ is different from Φ₂. In such an example the base station 105-b may estimate the channel for the first symbol and the second symbol. Stated alternatively, the base station 105-b may estimate the channel for each symbol independently. As such, the estimated channel for first reference signal may be ∞Hᵣ₁Φ₁Hᵣ₂ and the estimated channel for the second reference signal may be [symbol] ≈Hᵣ₁ Φ₂Hᵣ₂. Accordingly, the base station 105-b may detect the one or more bits of information communicated by the RIS 205-a based on the relationship between [symbol] and [symbol] .

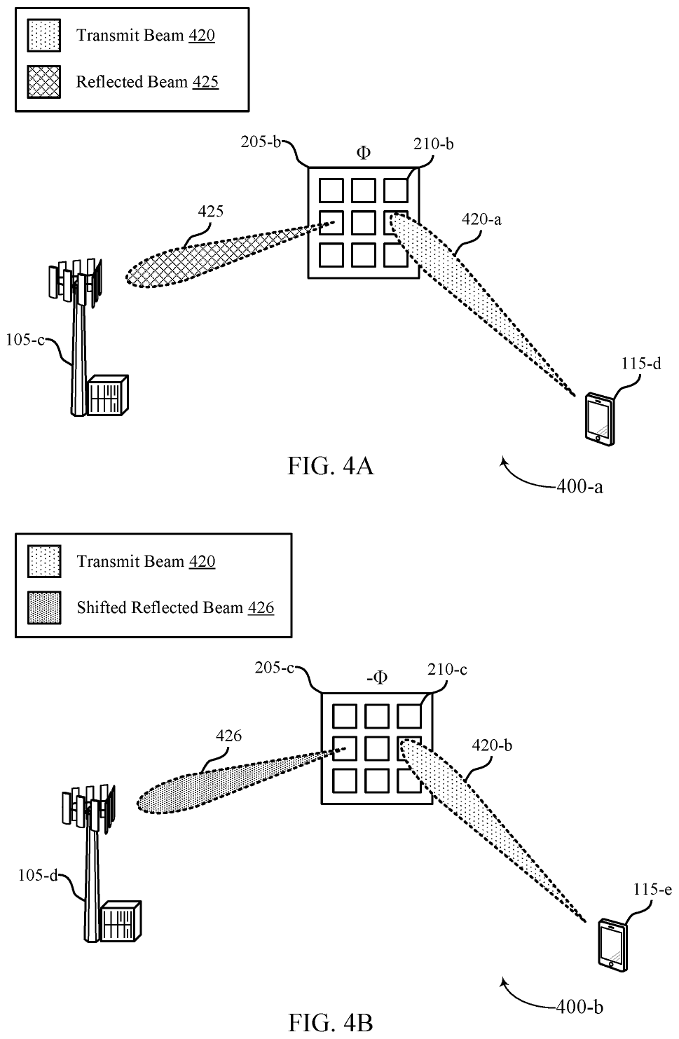

FIGS. 4A and 4B illustrate examples of wireless communications systems 400 that support techniques for passive communication of a reflective surface with a base station in accordance with aspects of the present disclosure. In some examples, wireless communications systems 400 may implement or be implemented by one or more aspects of the wireless communications systems 100, 200, and 300. For instance, each wireless communications system 400 may include one or more base stations 105 and one or more UEs 115, which may be examples of the corresponding devices described with reference to FIG. 1. Additionally, each wireless communications system 400 may include one or more RISs 205, which may be examples of the corresponding device as described with reference to FIGS. 2 and 3. The wireless communications systems 400 may include features for improved communications between the UEs 115 and the base stations 105, among other benefits.

Each wireless communications system 400 may illustrate a RIS 205 multiplexing feedback (e.g., one or more bits of information) with signals (e.g., reference signals) transmitted from a UE 115. For example, each wireless communications system 400 may include a UE 115 communicating with a base station 105 via a RIS 205. In some examples, the UE 115 may transmit a reference signal (e.g., a demodulation reference signals (DM-RSs)) to the RIS 205 via a transmit beam 420. The RIS 205 may receive and then reflect (e.g., via a reflected beam 225) the reference signal towards the base station 105. In some cases, the base station 105 may perform channel estimation on the received reference signal to determine the quality of the aggregate channel (e.g., the concatenation of the channel between the UE 115 and the RIS 205 and the channel between the RIS 205 and the base station 105). In some instances, the base station 105 may detect one or more bits of information communicated by the RIS 205 based on comparing the estimated channel of two or more reference signals reflected by the RIS 205.

In some examples, a RIS 205 may use phase shift keying (PSK) to multiplex one or more bits of information with reference signals transmitted from a UE 115. For instance, a RIS 205 may modulate the phase of reference signals transmitted from a UE 115 by shifting the configuration of reflective elements (e.g., a reflective elements 210) included in the RIS 205 by a constant value

$$( e . g . , π , \frac{π}{2} , or \frac{3 π}{2} ) .$$

In some cases, a RIS 205 may use binary phase shift keying (BPSK) to communicate one bit of information (e.g., ACK, NACK, or another feedback bit). For instance, a UE 115 may be configured to transmit two reference signals (e.g., in two separate symbols) to the base station 105 via the RIS 205. The RIS 205 may reflect the first refence signal according to a first configuration (Φ₁). In some cases, the first configuration may be an optimal configuration indicated by the base station 105 (e.g., Φ₁=Φ). In a first cases (e.g., to communicate ACK or other feedback), the RIS 205 may reflect the second reference signal according to a second configuration (Φ₂), where Φ₂ is phase shifted relative to Φ₁ (e.g., Φ₂=−Φ₁). In such an example, the estimated channel for the first reference signal may be [symbol] ≈Hᵣ₁Φ₁Hᵣ₂ and the estimated channel for the second reference signal may be [symbol] ≈Hᵣ₁(−Φ₁)Hᵣ₂. Thus, in the first case, a base station 105 may detect [symbol] =− [symbol] . In a second case (e.g., to communicate NACK or other feedback), the RIS 205 may reflect the second reference signal according to a second configuration (Φ₂) that is the same as the first configuration used to reflect the first reference signal (e.g., Φ₂=Φ₁). In such a case, the estimated channel for the first reference signal may be [symbol] ≈Hᵣ₁Φ₁Hᵣ₂ and the estimated channel for the second reference signal may be [symbol] ≈Hᵣ₁Φ₁Hᵣ₂. Thus, in the second case, a base station 105 may detect [symbol] = [symbol] . In some instances, a base station 105 may determine feedback based on determining whether [symbol] =− [symbol] or [symbol] = [symbol] . Stated alternatively, a base station may test two hypotheses ( [symbol] =− [symbol] and [symbol] = [symbol] ) to determine the feedback communicated by the RIS. For example, in the first case (e.g., where [symbol] =− [symbol] ), the base station 105 may determine that the RIS 205 communicated a first feedback (e.g., ACK), and in the second case (e.g., where [symbol] = [symbol] ), the base station 105 may determine that the RIS 205 communicated a second feedback (e.g., NACK). In some instances the techniques described herein may be generalized to higher-order PSK (e.g., QPSK) such that more than one bit of information may be communicated by the RIS 205. For example, a RIS 205 may use more than two reference signals or more than one reflective matrix (i.e., more than one Φ) to reflect each of the two reference signals.

In a first example, as illustrated in FIG. 4A, a RIS 205-b may be configured by a base station 105-c to receive reference signals transmitted from a UE 115-d via a transmit beam 420-a and then reflect (e.g., via reflected beam 425) the received reference signals towards the base station 105-c, according to Φ. In such examples the base station 105-c may estimate the channel of the reflected reference signals to be Ĥ ≈Hᵣ₁ΦHᵣ₂. In a second example, as illustrated in FIG. 4B, a RIS 205-c may reflect reference signals transmitted from the UE 115-e according to a configuration which is phase shifted relative to Φ (e.g., −Φ₁). For example, a RIS 205-c may receive reference signals transmitted from the UE 115-e via transmit beam 420-b and then reflect (e.g., via reflected beam 426) the received reference signals towards the base station 105-d, according to −Φ₁. In such examples the base station 105-c may estimate the channel to be Ĥ≈Hᵣ₁(−Φ₁)Hᵣ₂. In some instances, shifting the phase of reflective elements included in the RIS may alter the strength of the reflected beam. For example, the intensity of reflected beam 426 may be higher or lower (e.g., depending on the phase shift) relative to reflected beam 425. In some cases (e.g., to communicate ACK or other feedback), a RIS 205 may transmit a first reference signal according to the aspects of communications system 400-a and a second reference signal according to aspects of communications system 400-b. In some other cases (e.g., to communicate NACK or other feedback), a RIS 205 may transmit both a first and a second reference signal according to the aspects of communications system 400-a.

In some examples, a RIS 205 may multiplex information with information transmitted from a UE 115. For instance, a base station 105 may transmit control signaling (e.g., a downlink control information (DCI) message) to a UE 115, and in response the UE 115 may determine to transmit feedback (e.g., ACK, NACK, or other feedback) to the base station 105. In some cases, the UE 115 may transmit ACK, NACK, or other feedback via uplink control signaling. For example, a UE 115 may transmit ACK, NACK, or other feedback using the physical uplink control channel (PUCCH) format 0 including two symbols (e.g., using repetition). For instance, a UE 115 may have a payload X, and the UE 115 may transmit X on two symbols (e.g., [X,X]) to the base station 105 via the RIS 205. The RIS 205 may then multiplex feedback (e.g., ACK, NACK, or other feedback) for the base station 105 with the payload transmitted by the UE 115. For example, if a RIS 205 determines to communicate first feedback (e.g., ACK), the RIS 205 may reflect the first symbol according to Φ and may reflect the second symbol according to −Φ. In such an example the base station 105 may receive [X,−X]. In another example, if a RIS 205 determines to communicate second feedback (e.g., NACK), the RIS 205 may reflect the first symbol and the second symbol according to Φ. In such an example the base station 105 may receive [X,X]. Therefore, a base station 105 may simultaneously decode feedback from the RIS 205 and the UE 115.

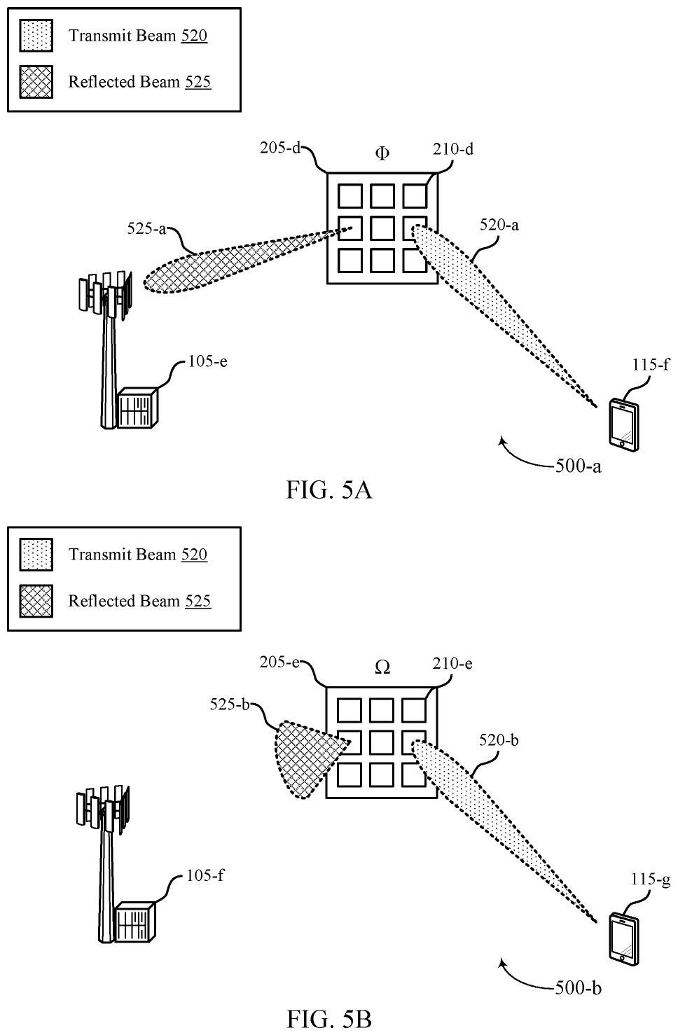

FIGS. 5A and 5B illustrate examples of wireless communications systems 500 that support techniques for passive communication of a reflective surface with a base station in accordance with aspects of the present disclosure. In some examples, wireless communications systems 500 may implement or be implemented by one or more aspects of the wireless communications systems 100, 200, 300, and 400. For instance, each wireless communications system 500 may include one or more base stations 105 and one or more UEs 115, which may be examples of the corresponding devices described with reference to FIG. 1. Additionally, each wireless communications system 500 may include one or more RISs 205 which may be examples of the corresponding device as described with reference to FIGS. 2 through 4. The wireless communications systems 500 may include features for improved communications between the UEs 115 and the base stations 105, among other benefits.

Each wireless communications system 500 may illustrate a RIS 205 communicating information to a base station 105 using orthogonal signaling. For example, each wireless communications system 500 may include a UE 115 communicating with a base station 105 via a RIS 205. In some examples, the UE 115 may transmit (e.g., via a transmit beam 520) one or more signals to the RIS 205 and the RIS 205 may reflect (e.g., via a reflected beam 225) each of the one or more signals towards the base station 105 according to a configuration. In some examples, a RIS 205 may one or more reference signals according to a first configuration and one or more reference signals according to a second configuration that may be orthogonal to the first configuration. For instance, in some cases, the first configuration may be an optimal configuration (Φ) indicated by a base station 105 and the second configuration may be an alternative configuration (Ω), where the values of the second configuration matrix are orthogonal to the values of the first configuration matrix.

In some cases, the RIS 205 may change the intensity of one or more signals transmitted from a UE 115 by reflecting one or more signals according to the alternative configuration (Ω). In some examples, Ω may a be a scatter configuration. For example, 22 may configure reflective elements (e.g., reflective elements 210) included in the RIS 205 such that signals reflected by the RIS 205 are scattered (i.e., reflect in all directions) and the likelihood of the base station 105 receiving the signal is low. In some other examples, Ω may configure reflective elements included in the RIS 205 such that signals reflected by the RIS 205 are wider (i.e., more diffuse) than beams reflected according to Φ. In yet another example a RIS 205 may turn off (e.g., deactivate) and not reflect one or more signals towards a base station 105. The base station 105 may perform reference signal receive power (RSRP) measurements on signals (e.g., reference signals) transmitted from a UE 115 via the RIS 205. In some cases, RSRP values measured for reference signals reflected according to Φ may be higher than RSRP values measured for reference signals reflected according to Ω or signals which are not reflected by the RIS 205 at all. Therefore, a base station 105 may detect one or more bits of information communicated by a RIS 205 based on comparing RSRP measurements of two or more reference signals.

In some examples, a UE 115 may be configured to transmit two reference signals (e.g., via transmit beam 520) in two symbols to a base station 105 via a RIS 205. The RIS 205 may communicate feedback (e.g., ACK, NACK, or other feedback) by reflecting each of the two reference signals according to different configurations. For example, the RIS 205 may reflect the first reference signal according to a first configuration and may reflect the second reference signal according to a second configuration. In some case, for example to indicate first feedback (e.g., ACK), the first configuration may be an optimal configuration indicated by a base station 105 (Φ) and second configuration may be a scatterer configuration (Ω). In some other cases, for example to indicate second feedback (e.g., NACK), the first configuration be a scatterer configuration (Ω) and the second configuration may be an optimal configuration indicated by a base station 105 (Φ). The base station 105 may perform RSRP measurements on the first symbol (e.g., the symbol used to transmit the first reference signal) and the second symbol (e.g., the symbol used to transmit the second reference signal). In some instances, a base station may determine whether a RIS 205 is communicating ACK, NACK, or other feedback by comparing the received signal strength (e.g., the measured RSRP) of the first and second symbols. In some cases, if the measured RSRP of the first symbol is greater than the measured RSRP of the second symbol, the base station 105 may determine first feedback (e.g., ACK). Alternatively, if the RSRP measurement of the first symbol is less than the RSRP measurements of the second symbol, the base station 105 may determine second feedback (e.g., NACK). In some examples, a RIS 205 may increase the number of bits communicated to a base station 105 by increasing the number of reference signals through which the information is communicated.

FIG. 5A illustrates an example of a RIS 205 reflecting a signal (e.g., a reference signal) according to Φ. For example, a reference signal may be transmitted by a UE 115-f via a transmit beam 520-a to a RIS 205-d. The RIS 205-d may receive and then reflect (e.g., via the reflected beam 525-a) the reference signal towards the base station 105-e according to Φ. In some cases, Φ may be indicated to the RIS 205-d via the base station 105-e, for example, via control signaling. The base station 105-e may receive the reference signal (e.g., reflected beam 525-a) and perform an RSRP measurement. FIG. 5B illustrates an example of a RIS 205 reflecting a reference signal according to Ω. For example, a UE 115-g may transmit a reference signal via a transmit beam 520-b. The RIS 205-e may receive and then reflect (e.g., via reflected beam 525-b) the reference signal according to Ω. In such a case, reflected beam 525-b may be wider than reflected beam 525-a, which is described with reference to FIG. 5A. The base station 105-f may receive the reference signal (e.g., via reflected beam 525-b) and perform an RSRP measurement. In some cases, the RSRP value measured for the reflected beam 525-b may be less than the RSRP value measured for the reflected beam 525-a, which is described with reference to FIG. 5A.

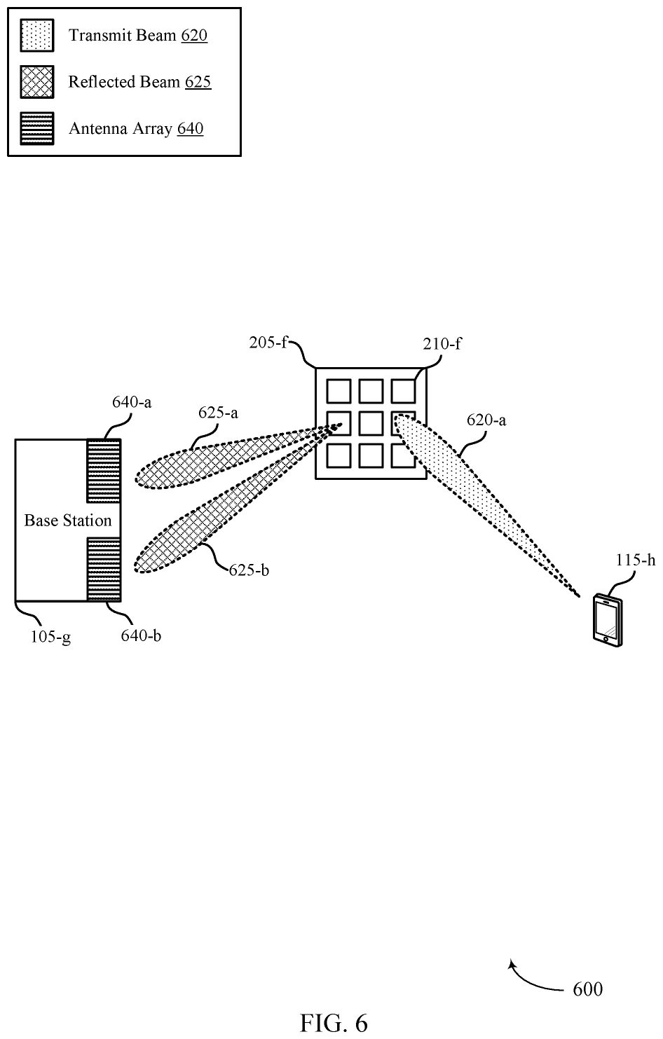

FIG. 6 illustrates an example of wireless communications system 600 that supports techniques for passive communication of a reflective surface with a base station in accordance with aspects of the present disclosure. In some examples, wireless communications system 600 may implement or be implemented by one or more aspects of the wireless communications systems 100, 200, 300, 400, and 500. For instance, wireless communications system 600 may include one or more base stations 105 and one or more UEs 115, which may be examples of the corresponding devices described with reference to FIG. 1. Additionally, wireless communications system 600 may include one or more RISs 205 which may be examples of the corresponding device as described with reference to FIGS. 2 through 5. The wireless communications system 600 may include features for improved communications between the UEs 115 and the base stations 105, among other benefits.

The wireless communications system 600 illustrates a RIS 205 communicating feedback to a base station 105 by reflecting (e.g., via a reflected beam 625) one or more signals (e.g., reference signals) transmitted from a UE 115 (e.g., via a transmit beam 620) towards an antenna array 640. In some instances an antenna array may be referred to as an antenna panel. In some examples, as illustrated in FIG. 6, the base station 105-g may include a first antenna array 640-a and a second antenna array 640-b. In some cases, the RIS 205-f may be configured by the base station 105-g (e.g., via control signaling) with a first configuration (Φ₁) for the first antenna array 640-a and a second configuration (Φ₂) for the second antenna array 640-b. In some cases, Φ₁ may include phase information for reflective elements (e.g., a reflective element 210-f) included in the RIS 205-f such that signals transmitted to the RIS 205-f are reflected towards the first antenna array 640-a. Similarly, Φ₂ may include phase information for reflective elements (e.g., reflective element 210-f) included in the RIS 205-f such that signals transmitted to the RIS 205-f are reflected towards the second antenna array 640-b. Thus, the base station 105-g may determine feedback communicated by the RIS 205-f based on the antenna array at which reference signals are detected. Stated alternatively, the base station 105-g may determine whether the RIS 205-f is communicating ACK, NACK, or other feedback based on comparing the receive energy over the two antenna arrays (e.g., antenna array 640-a and antenna array 640-b).

For example, a UE 115-h may be configured to transmit (e.g., via a transmit beam 620-a) a reference signal to a base station 105-g via a RIS 205-f. In some case, for example to indicate first feedback (e.g., ACK), the RIS 205-f may reflect (e.g., via reflected beam 625-a) the reference signal according to Φ₁, such that the reference signal is received by the base station 105-g at antenna array 640-a. In some other cases, for example to indicate second feedback (e.g., NACK), the RIS 205-f may reflect (e.g., via reflected beam 625-b) the reference signal according to Φ₂, such that the reference signal is received by the base station 105-g at antenna array 640-b. In some instances, the base station 105-g may determine the receive energy at the antenna arrays 640. In some cases, if the receive energy at the first antenna array 640-a is greater than the receive energy at the second antenna array 640-b, the base station may determine first feedback (e.g., ACK). Additionally or alternatively, if the receive energy at the first antenna array 640-a is less than the receive energy at the second antenna array 640-b, the base station may determine second feedback (e.g., NACK). In some examples, the antenna arrays 640 may be located at a single base station (e.g., the base station 105-g or another TRP). In some other examples, the antenna arrays 640 may be located at multiple base stations or multiple other TRPs. In some cases, TRPs may include relay nodes or radio heads (e.g., smart radio heads). Additionally, a RIS 205-f may communicate two or more bits of information by reflecting signals according to a code division multiple access (CDMA) pattern across the antenna arrays 640. Stated alternatively, the aspects described with reference to FIG. 6 may be generalized via CDMA patterns across the antennas or antenna panels.

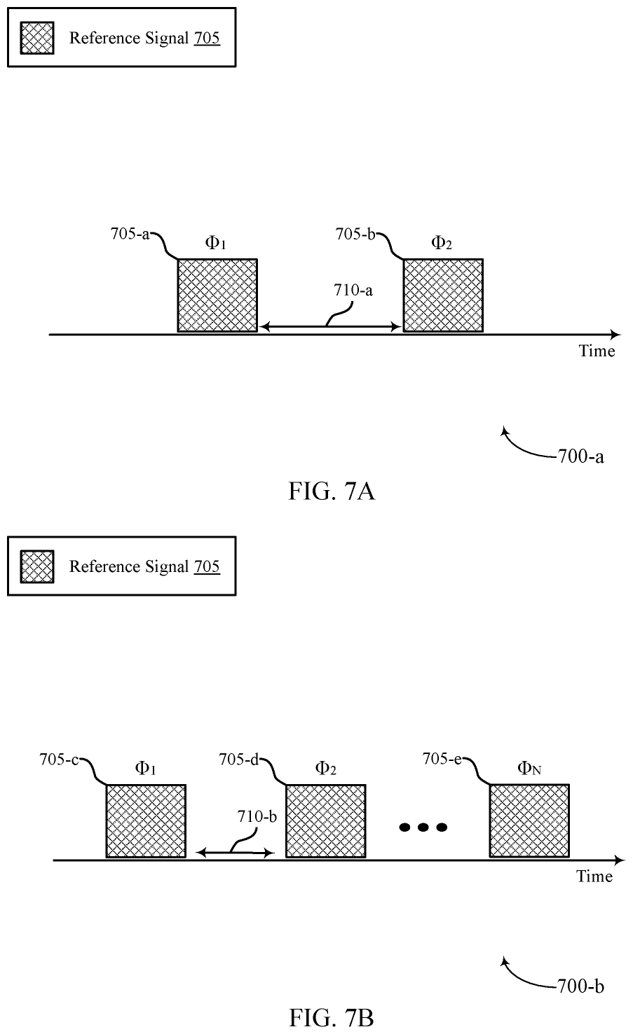

FIGS. 7A and 7B illustrate examples of timing diagrams 700 that support techniques for passive communication of a reflective surface with a base station in accordance with aspects of the present disclosure. In some examples, timing diagrams 700 may implement or be implemented by one or more aspects of the wireless communications systems 100, 200, 300, 400, 500, and 600. For instance, each timing diagram 700 may illustrate operations performed at one or more base stations 105 and one or more UEs 115, which may be examples of the corresponding devices described with reference to FIG. 1. Additionally, each timing diagram 700 may illustrate operations performed at one or more RISs 205 which may be examples of the corresponding device as described with reference to FIGS. 2 and 6.

A UE may be scheduled to transmit one or more signals (e.g., reference signals 705) on one or more symbols (e.g., one or more separate symbols) to a base station 105 via a RIS 205. In some cases (e.g., to communicate feedback), a RIS 205 may reflect two or more reference signals transmitted by a UE 115 according to two or more configurations. In such cases, the RIS 205 may expend an amount of time transitioning from a current state (e.g., configuration) to a subsequent state (e.g., configuration). Accordingly, it may be desirable for a UE 115 to not transmit the two or more reference signals on consecutive symbols. Stated alternatively, depending on the response time (i.e., the time used to reconfigure the reflective elements) of the RIS 205, reference signals 705 may not be transmitted on consecutive symbols. Rather, reference signals 705 may be transmitted on symbols separated by a time gap 710. In some cases, a time gap 710 may be longer than the amount of time a RIS 205 may use to reconfigure the reflective elements of the RIS 205.

For example, as illustrated in timing diagram 700-a, a UE 115 may be scheduled to transmit a reference signal 705-a and a reference signal 705-b. In some cases (e.g., to communicate feedback), a RIS 205 may determine to reflect the reference signal 705-a according to a first configuration (Φ₁) and reflect reference signal 705-b according to a second configuration (Φ₂), where Φ₁ is different from Φ₂. In such a case, a UE 115 may be configured (e.g., by a base station 105) to transmit the reference signal 705-a and then, after a time gap 710-a, transmit the reference signal 705-b. As such, a RIS 205 may transition from Φ₁ to Φ₂ during the time gap 710. Stated alternatively, a RIS 205 may transition from Φ₁ to Φ₂ after the RIS reflects the reference signal 705-a and before the UE 115 transmits the reference signal 705-b, such that reference signal 705-a may be reflected according to Φ₁ and reference signal 705-b may be reflected according to Φ₂. In some cases, a base station 105 may reconfigure (e.g., via RRC signaling) the time gap 710 based on feedback communicated from the RIS 205.

In some examples, a RIS 205 may increase the reliability of communication with a base station 105, or increase the number of bits being communicated to a base station 105, by increasing the number of reference signals 705 used for the communication. For example, if a UE 115 is scheduled to transmit multiple reference signals to a base station 105 via a RIS 205, the RIS 205 may communicate multiple bits of information to the base station 105 by reflecting the multiple reference signals according to multiple configurations. For instance, as illustrated in timing diagram 700-b, a UE 115 may be scheduled to transmit a number (N) of reference signals 705 to a base station 105 via a RIS 205, for example according to a sequence. Each reference signal 705 may be separated by a time gap 710-b. In some cases, a base station 105 may indicate (e.g., via control signaling) an optimal configuration (Φ) to the RIS 205. In such a case, the RIS 205 may communicate a sequence of bits, for example {b₂, b₃, . . . , b₁, . . . , b_{N}} where bᵢ ∈{0,1}, by reflecting the sequence of reference signals 705 according to a sequence of configurations, for example (Φ₁, Φ₂, . . . , Φₖ , . . . , Φ_{N})=(Φ, e^{jaπb}^{₂}Φ, e^{jaπb}^{₃}Φ, . . . , e^{jaπb}^{ᵢ}Φ, . . . , e^{jaπb}^{_{N}}Φ) where −1≤α≤1. In some instances, a may depend on physical limitations of a RIS 205 or other factors.

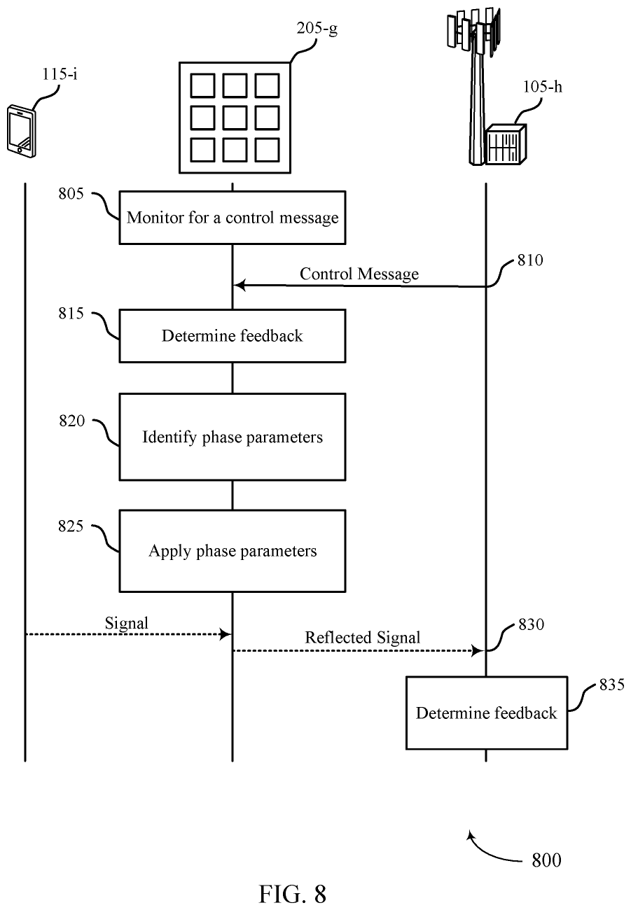

FIG. 8 illustrates an example of a process flow 800 that supports techniques for passive communication of a reflective surface with a base station in accordance with aspects of the present disclosure. In some examples, the process flow 800 may implement one or more aspects of wireless communications systems 100, 200, 300, 400, 500, and 600. For example, the process flow 800 may include example operations associated with a base station 105-h and a UE 115-i, which may be examples of the corresponding devices described with reference to FIGS. 1 through 6. Additionally, the process flow 800 may include example operations associated with a RIS 205-g, which may be an example of corresponding devices as described with reference to FIGS. 2 through 6. The operations performed by the base station 105-h, the RIS 205-g, and the UE 115-i may support improvements to communications between the UE 115-i and the base station 105-h, among other benefits.

At 805, a RIS 205-g may monitor for a control message, from a base station 105-h, directed to the RIS 205-g. At 810, the base station 105-h may transmit a control message directed to the RIS 205-g. In some cases, the control message (e.g., an RRC message) may indicate phase information for reflective elements included in the RIS 205.

At 815, the RIS 205-g may determine feedback based on monitoring for the control message. In some cases, the feedback may be positive feedback (e.g., ACK) and in some other cases, the feedback may be negative feedback (e.g., NACK) or other feedback. In some instances, the feedback may be based on whether the RRC message was successfully received by the RIS 205-g.

At 820, the RIS 205-g may identify a first set of phase parameters for the RIS 205-g and a second set of phase parameters for the RIS 205-g, where both the first set of phase parameters and the second set of phase parameters may be usable by the RIS 205-g to reflect communications between a UE 115-i and the base station 105-h. For example, the first and second set of phase parameters may each include relative phase information for reflective elements included in the RIS 205-g. At 825 the RIS 205-g may apply the first set of phase parameters and the second set of phase parameters to multiplex the feedback on at least one signal from the UE 115-i reflected to the base station via the RIS 205-g.

At 830 the base station 105-h may receive the at least one signal reflected to the base station by the RIS 205-g from a UE 115-i, where the at least one signal may be indicative of at least one of a first set of phase parameters applied at the RIS 205-g for reflecting the at least one signal or a second set of phase parameters applied at the RIS 205-g for reflecting the at least one signal.

At 835 the base station 105-h may determine the feedback by the RIS 205-g for the control message based on the at least one signal being reflected at the RIS 205-g using at least one of the first set of phase parameters or the second set of phase parameters.

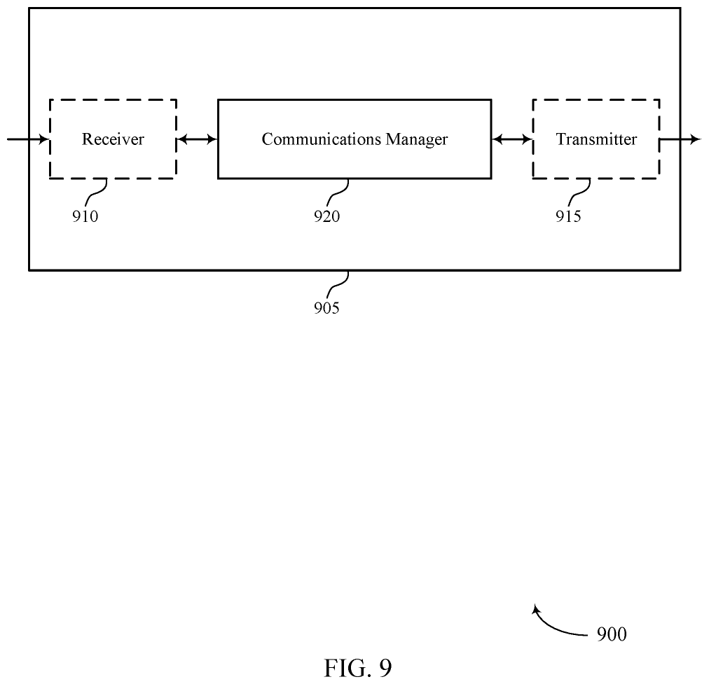

FIG. 9 shows a block diagram 900 of a device 905 that supports techniques for passive communication of a reflective surface with a base station in accordance with aspects of the present disclosure. In some examples, the device 905 may be an example of aspects of a reflective surface (e.g., a RIS 205) as described herein. In some cases, the device 905 may include a receiver 910, a transmitter 915, and a communications manager 920. The device 905 may also include a processor. In some cases, each of these components may be in communication with one another (e.g., via one or more buses).

In some cases, the receiver 910 may provide a means for receiving information such as packets, user data, control information, or any combination thereof associated with various information channels (e.g., control channels, data channels, information channels related to techniques for passive communication of a reflective surface with a base station). In some cases, information may be passed on to other components of the device 905. In some cases, the receiver 910 may utilize a single antenna or a set of multiple antennas.

In some cases, the transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for passive communication of a reflective surface with a base station). In some cases, the transmitter 915 may be co-located with a receiver 910 in a transceiver module. In some cases, the transmitter 915 may utilize a single antenna or a set of multiple antennas.

In some examples, the communications manager 920, the receiver 910, the transmitter 915, or various combinations thereof or various components thereof may be examples of means for performing various aspects of techniques for passive communication of a reflective surface with a base station as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). In some cases, the hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. In some cases, if implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a reconfigurable reflective surface in accordance with examples as disclosed herein. For example, the communications manager 920 may be configured as or otherwise support a means for monitoring for a control message, from a base station, directed to the reconfigurable reflective surface. The communications manager 920 may be configured as or otherwise support a means for determining feedback based on monitoring for the control message. The communications manager 920 may be configured as or otherwise support a means for identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station. The communications manager 920 may be configured as or otherwise support a means for applying the first set of phase parameters and the second set of phase parameters to multiplex the feedback on at least one signal from the UE reflected to the base station via the reconfigurable reflective surface.

In some examples, by including or configuring the communications manager 920 in accordance with examples as described herein, the device 905 (e.g., a processor controlling or otherwise coupled to the receiver 910, the transmitter 915, the communications manager 920, or a combination thereof) may support techniques for passive communication of a reflective surface with a base station, which, in some cases, may extend communications coverage around, or because of, blockages with negligible power consumption costs.

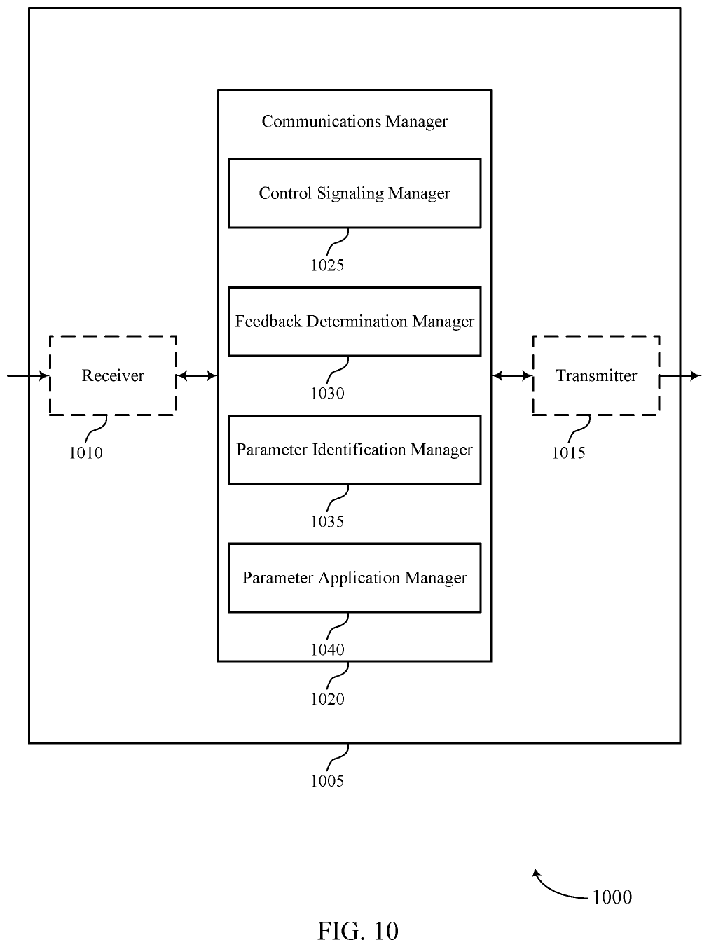

FIG. 10 shows a block diagram 1000 of a device 1005 that supports techniques for passive communication of a reflective surface with a base station in accordance with aspects of the present disclosure. In some examples, the device 1005 may be an example of aspects of a device 905 or a reflective surface (e.g., a RIS 205) as described herein. In some cases, the device 1005 may include a receiver 1010, a transmitter 1015, and a communications manager 1020. The device 1005 may also include a processor. In some cases, each of these components may be in communication with one another (e.g., via one or more buses).

In some cases, the receiver 1010 may provide a means for receiving information such as packets, user data, control information, or any combination thereof associated with various information channels (e.g., control channels, data channels, information channels related to techniques for passive communication of a reflective surface with a base station). In some cases, information may be passed on to other components of the device 1005. In some cases, the receiver 1010 may utilize a single antenna or a set of multiple antennas.

In some cases, the transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for passive communication of a reflective surface with a base station). In some cases, the transmitter 1015 may be co-located with a receiver 1010 in a transceiver module. In some cases, the transmitter 1015 may utilize a single antenna or a set of multiple antennas.

The device 1005, or various components thereof, may be an example of means for performing various aspects of techniques for passive communication of a reflective surface with a base station as described herein. For example, the communications manager 1020 may include a control signaling manager 1025, a feedback determination manager 1030, a parameter identification manager 1035, a parameter application manager 1040, or any combination thereof. In some examples, the communications manager 1020 may be an example of aspects of a communications manager 920 as described herein. In some cases, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a reconfigurable reflective surface in accordance with examples as disclosed herein. The control signaling manager 1025 may be configured as or otherwise support a means for monitoring for a control message, from a base station, directed to the reconfigurable reflective surface. The feedback determination manager 1030 may be configured as or otherwise support a means for determining feedback based on monitoring for the control message. The parameter identification manager 1035 may be configured as or otherwise support a means for identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station. The parameter application manager 1040 may be configured as or otherwise support a means for applying the first set of phase parameters and the second set of phase parameters to multiplex the feedback on at least one signal from the UE reflected to the base station via the reconfigurable reflective surface.

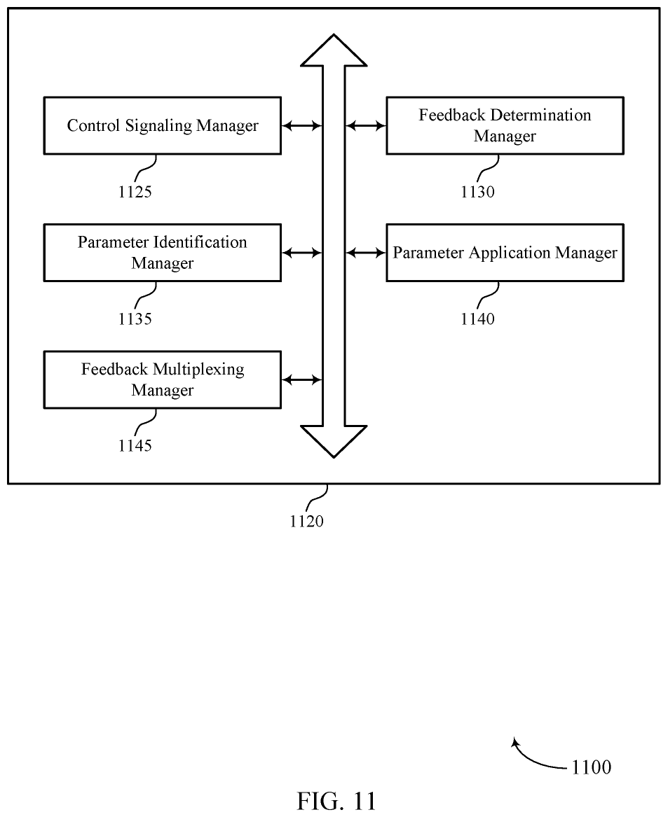

FIG. 11 shows a block diagram 1100 of a communications manager 1120 that supports techniques for passive communication of a reflective surface with a base station in accordance with aspects of the present disclosure. The communications manager 1120 may be an example of aspects of a communications manager 920, a communications manager 1020, or both, as described herein. The communications manager 1120, or various components thereof, may be an example of means for performing various aspects of techniques for passive communication of a reflective surface with a base station as described herein. For example, the communications manager 1120 may include a control signaling manager 1125, a feedback determination manager 1130, a parameter identification manager 1135, a parameter application manager 1140, a feedback multiplexing manager 1145, or any combination thereof. Each of these components may communicate, directly or indirectly, with one another (e.g., via one or more buses).

The communications manager 1120 may support wireless communications at a reconfigurable reflective surface in accordance with examples as disclosed herein. The control signaling manager 1125 may be configured as or otherwise support a means for monitoring for a control message, from a base station, directed to the reconfigurable reflective surface. The feedback determination manager 1130 may be configured as or otherwise support a means for determining feedback based on monitoring for the control message. The parameter identification manager 1135 may be configured as or otherwise support a means for identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station. The parameter application manager 1140 may be configured as or otherwise support a means for applying the first set of phase parameters and the second set of phase parameters to multiplex the feedback on at least one signal from the UE reflected to the base station via the reconfigurable reflective surface.

In some examples, to support identifying the first set of phase parameters for the reconfigurable reflective surface and the second set of phase parameters for the reconfigurable reflective surface, the parameter identification manager 1135 may be configured as or otherwise support a means for identifying a first configuration matrix for a first one or more reflective components at the reconfigurable reflective surface. In some examples, to support identifying the first set of phase parameters for the reconfigurable reflective surface and the second set of phase parameters for the reconfigurable reflective surface, the parameter identification manager 1135 may be configured as or otherwise support a means for identifying a second configuration matrix for a second one or more reflective components at the reconfigurable reflective surface, where values of the second configuration matrix have opposite signs as values of the first configuration matrix.

In some examples, the feedback multiplexing manager 1145 may be configured as or otherwise support a means for multiplexing the feedback onto a combination of a first signal and a second signal from the UE by reflecting the first signal using the first set of phase parameters in accordance with the first configuration matrix and reflecting the second signal using the second set of phase parameters in accordance with the second configuration matrix, where the at least one signal includes the first signal and the second signal.

In some examples, the feedback multiplexing manager 1145 may be configured as or otherwise support a means for multiplexing the feedback onto a combination of a first signal and a second signal from the UE by reflecting the first signal using the first set of phase parameters in accordance with the first configuration matrix and reflecting the second signal using the second set of phase parameters in accordance with the first configuration matrix, where the at least one signal includes the first signal and the second signal.

In some examples, to support identifying the first set of phase parameters for the reconfigurable reflective surface and the second set of phase parameters for the reconfigurable reflective surface, the parameter identification manager 1135 may be configured as or otherwise support a means for identifying a first configuration matrix for a first one or more reflective components at the reconfigurable reflective surface. In some examples, to support identifying the first set of phase parameters for the reconfigurable reflective surface and the second set of phase parameters for the reconfigurable reflective surface, the parameter identification manager 1135 may be configured as or otherwise support a means for identifying a second configuration matrix for a second one or more reflective components at the reconfigurable reflective surface, where values of the second configuration matrix weaken signal reception at the base station with respect to values of the first configuration matrix.

In some examples, the feedback multiplexing manager 1145 may be configured as or otherwise support a means for multiplexing the feedback onto a first signal from the UE, a second signal from the UE, or both, by reflecting the first signal using the first set of phase parameters in accordance with the first configuration matrix, reflecting the second signal using the second set of phase parameters in accordance with the second configuration matrix, or both, where the at least one signal includes the first signal, the second signal, or both.

In some examples, the values of the second configuration matrix are orthogonal to the values of the first configuration matrix.

In some examples, the values of the second configuration matrix scatter a second signal with respect to application of the values of the first configuration matrix to a first signal.

In some examples, the values of the second configuration matrix produce a wider beam than the values of the first configuration matrix.

In some examples, to support applying the first set of phase parameters and the second set of phase parameters, the parameter application manager 1140 may be configured as or otherwise support a means for deactivating the second one or more reflective components, where the signal reception at the base station is weakened based on deactivating the second one or more reflective components.

In some examples, to support identifying the first set of phase parameters for the reconfigurable reflective surface and the second set of phase parameters for the reconfigurable reflective surface, the parameter identification manager 1135 may be configured as or otherwise support a means for identifying a first configuration matrix for a first one or more reflective components at the reconfigurable reflective surface. In some examples, to support identifying the first set of phase parameters for the reconfigurable reflective surface and the second set of phase parameters for the reconfigurable reflective surface, the parameter identification manager 1135 may be configured as or otherwise support a means for identifying a second configuration matrix for a second one or more reflective components at the reconfigurable reflective surface, where values of the first configuration matrix and the second configuration matrix are based on a code division multiple access (CDMA) pattern associated with a first antenna panel and a second antenna panel at the base station.

In some examples, the feedback multiplexing manager 1145 may be configured as or otherwise support a means for multiplexing the feedback onto the at least one signal from the UE by reflecting the at least one signal to the first antenna panel using the first set of phase parameters in accordance with the first configuration matrix and reflecting the at least one signal to the second antenna panel using the second set of phase parameters in accordance with the second configuration matrix, where the CDMA pattern includes a first energy level associated with reception of the at least one signal at the first antenna panel and a second energy level associated with reception of the at least one signal at the second antenna panel.

In some examples, the control signaling manager 1125 may be configured as or otherwise support a means for receiving the control message based on the monitoring for the control message, where the feedback includes an acknowledgement message based on the receiving the control message.

In some examples, to support applying the first set of phase parameters and the second set of phase parameters, the parameter application manager 1140 may be configured as or otherwise support a means for applying a first configuration matrix for a first one or more reflective components at the reconfigurable reflective surface to reflect a first signal from the UE to the base station in accordance with the first set of phase parameters. In some examples, to support applying the first set of phase parameters and the second set of phase parameters, the parameter application manager 1140 may be configured as or otherwise support a means for applying a second configuration matrix for a second one or more reflective components at the reconfigurable reflective surface to reflect a second signal from the UE to the base station in accordance with the second set of phase parameters, where the at least one signal includes both the first signal and the second signal.

In some examples, the first signal is received from the UE in a first symbol, and the second signal is received from the UE in a second symbol.

In some examples, the first symbol and the second symbol are separated by a time gap.

In some examples, the control signaling manager 1125 may be configured as or otherwise support a means for receiving control signaling indicating a size of a time gap between the first symbol and the second symbol, where applying the first set of phase parameters and the second set of phase parameters is based on receiving the control signaling.

In some examples, the first signal includes a first repetition of an uplink control channel, and the second signal includes a second repetition of the uplink control channel.

In some examples, the first set of phase parameters indicates a first bit of a bit sequence. In some examples, the second set of phase parameters indicates a second bit of the bit sequence. In some examples, the feedback includes the bit sequence.

In some examples, the at least one signal carries one or more feedback bits from the UE.

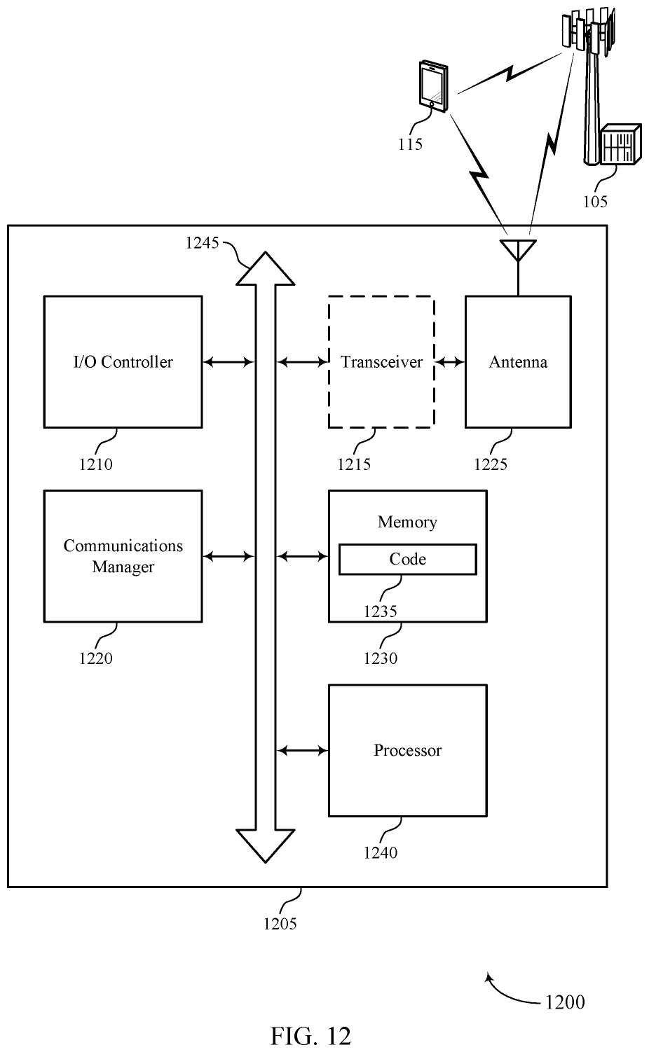

FIG. 12 shows a diagram of a system 1200 including a device 1205 that supports techniques for passive communication of a reflective surface with a base station in accordance with aspects of the present disclosure. In some examples, the device 1205 may be an example of or include the components of a device 905, a device 1005, or a reflective surface (e.g., a RIS 205) as described herein. The device 1205 may communicate wirelessly with one or more base stations 105, UEs 115, or any combination thereof. In some cases, the device 1205 may include components for bi-directional voice and data communications including, for example, components for transmitting and receiving communications, such as a communications manager 1220, an input/output (I/O) controller 1210, a transceiver 1215, an antenna 1225, a memory 1230, code 1235, and a processor 1240. In some cases, these components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which, in some cases, may be capable of concurrently transmitting or receiving multiple wireless transmissions. In some cases, the transceiver 1215 may communicate bi-directionally, via the one or more antennas 1225, wired, or wireless links as described herein. For example, the transceiver 1215 may represent a wireless transceiver and may communicate bi-directionally with another wireless transceiver. In some cases, the transceiver 1215 may also include a modem to modulate the packets, to provide the modulated packets to one or more antennas 1225 for transmission, and to demodulate packets received from the one or more antennas 1225. In some cases, the transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for passive communication of a reflective surface with a base station). For example, the device 1205 or a component of the device 1205 may include a processor 1240 and memory 1230 coupled to the processor 1240, the processor 1240 and memory 1230 configured to perform various functions described herein.

The communications manager 1220 may support wireless communications at a reconfigurable reflective surface in accordance with examples as disclosed herein. For example, the communications manager 1220 may be configured as or otherwise support a means for monitoring for a control message, from a base station, directed to the reconfigurable reflective surface. The communications manager 1220 may be configured as or otherwise support a means for determining feedback based on monitoring for the control message. The communications manager 1220 may be configured as or otherwise support a means for identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station. The communications manager 1220 may be configured as or otherwise support a means for applying the first set of phase parameters and the second set of phase parameters to multiplex the feedback on at least one signal from the UE reflected to the base station via the reconfigurable reflective surface.

By including or configuring the communications manager 1220 in accordance with examples as described herein, the device 1205 may support techniques for improved communication reliability, reduced latency, reduced power consumption, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for passive communication of a reflective surface with a base station as described herein, or the processor 1240 and the memory 1230 may be otherwise configured to perform or support such operations.

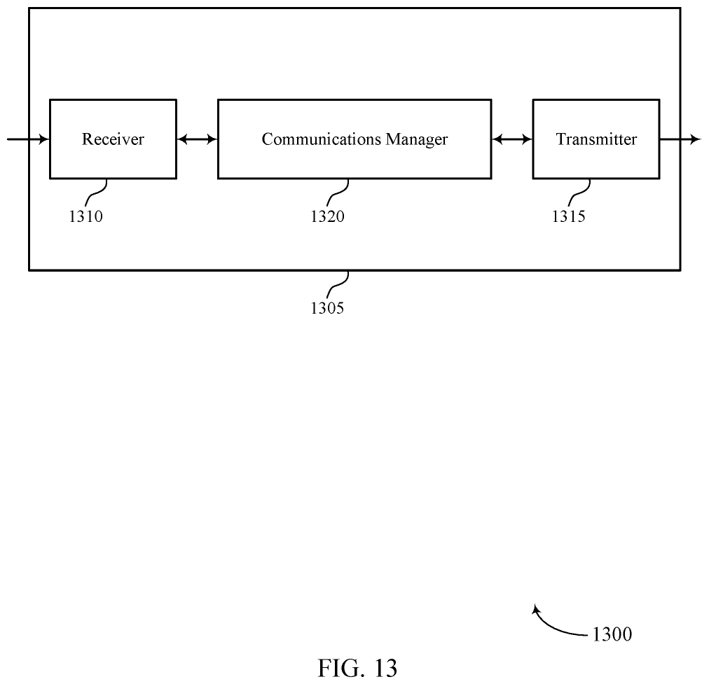

FIG. 13 shows a block diagram 1300 of a device 1305 that supports techniques for passive communication of a reflective surface with a base station in accordance with aspects of the present disclosure. The device 1305 may be an example of aspects of a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to techniques for passive communication of a reflective surface with a base station). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to techniques for passive communication of a reflective surface with a base station). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of techniques for passive communication of a reflective surface with a base station as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a base station in accordance with examples as disclosed herein. For example, the communications manager 1320 may be configured as or otherwise support a means for transmitting a control message directed to a reconfigurable reflective surface. The communications manager 1320 may be configured as or otherwise support a means for receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal. The communications manager 1320 may be configured as or otherwise support a means for determining a feedback by the reconfigurable reflective surface for the control message based on the at least one signal being reflected at the reconfigurable reflective surface using at least one of the first set of phase parameters or the second set of phase parameters.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for improved communication reliability, reduced latency, reduced power consumption, more efficient utilization of communication resources, and improved coordination between devices.

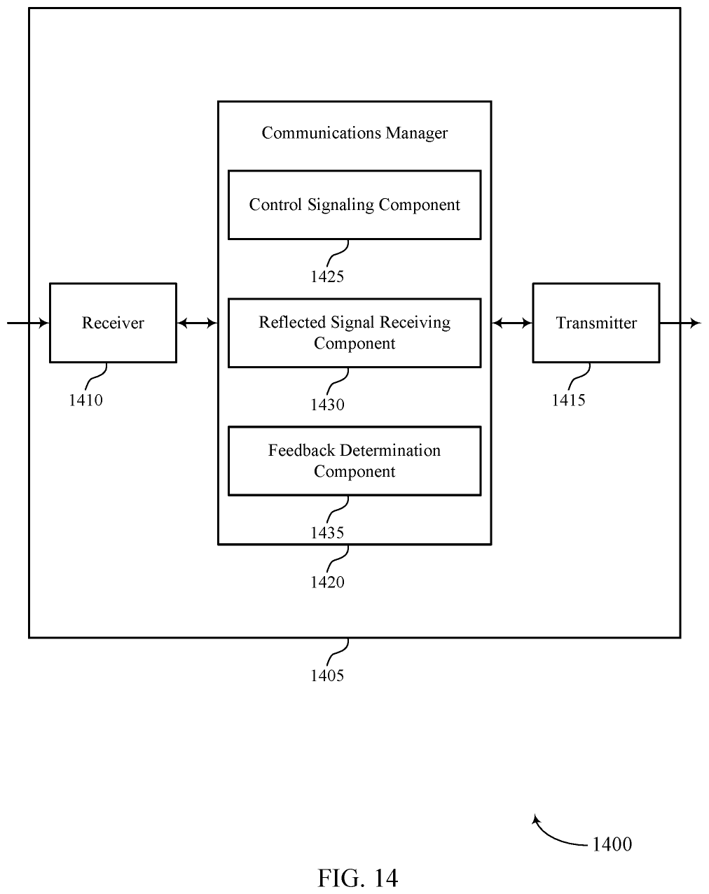

FIG. 14 shows a block diagram 1400 of a device 1405 that supports techniques for passive communication of a reflective surface with a base station in accordance with aspects of the present disclosure. The device 1405 may be an example of aspects of a device 1305 or a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to techniques for passive communication of a reflective surface with a base station). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to techniques for passive communication of a reflective surface with a base station). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of techniques for passive communication of a reflective surface with a base station as described herein. For example, the communications manager 1420 may include a control signaling component 1425, a reflected signal receiving component 1430, a feedback determination component 1435, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communications at a base station in accordance with examples as disclosed herein. The control signaling component 1425 may be configured as or otherwise support a means for transmitting a control message directed to a reconfigurable reflective surface. The reflected signal receiving component 1430 may be configured as or otherwise support a means for receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal. The feedback determination component 1435 may be configured as or otherwise support a means for determining a feedback by the reconfigurable reflective surface for the control message based on the at least one signal being reflected at the reconfigurable reflective surface using at least one of the first set of phase parameters or the second set of phase parameters.

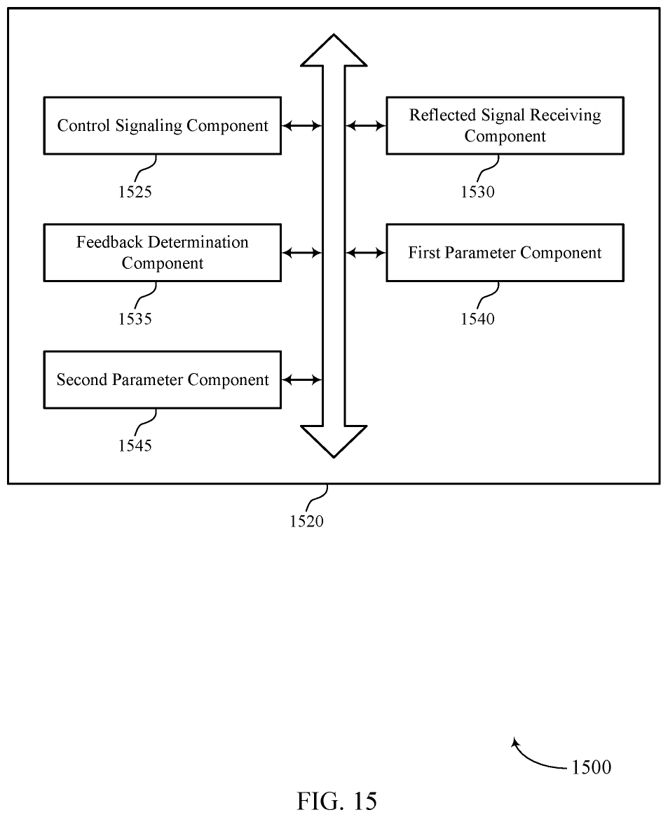

FIG. 15 shows a block diagram 1500 of a communications manager 1520 that supports techniques for passive communication of a reflective surface with a base station in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of techniques for passive communication of a reflective surface with a base station as described herein. For example, the communications manager 1520 may include a control signaling component 1525, a reflected signal receiving component 1530, a feedback determination component 1535, a first parameter component 1540, a second parameter component 1545, or any combination thereof. Each of these components may communicate, directly or indirectly, with one another (e.g., via one or more buses).

The communications manager 1520 may support wireless communications at a base station in accordance with examples as disclosed herein. The control signaling component 1525 may be configured as or otherwise support a means for transmitting a control message directed to a reconfigurable reflective surface. The reflected signal receiving component 1530 may be configured as or otherwise support a means for receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal. The feedback determination component 1535 may be configured as or otherwise support a means for determining a feedback by the reconfigurable reflective surface for the control message based on the at least one signal being reflected at the reconfigurable reflective surface using at least one of the first set of phase parameters or the second set of phase parameters.

In some examples, to support receiving the at least one signal reflected to the base station by the reconfigurable reflective surface from the UE, the reflected signal receiving component 1530 may be configured as or otherwise support a means for receiving a first signal indicative of the first set of phase parameters applied at the reconfigurable reflective surface for reflecting the first signal. In some examples, to support receiving the at least one signal reflected to the base station by the reconfigurable reflective surface from the UE, the reflected signal receiving component 1530 may be configured as or otherwise support a means for receiving a second signal indicative of the second set of phase parameters applied at the reconfigurable reflective surface for reflecting the second signal, where a first channel estimate for the first signal and a second channel estimate for the second signal indicate the feedback for the reconfigurable reflective surface for the control message.

In some examples, to support determining the feedback by the reconfigurable reflective surface for the control message, the feedback determination component 1535 may be configured as or otherwise support a means for determining the feedback by identifying that a first value of the first channel estimate has an opposite sign as a second value of the second channel estimate, where the at least one signal includes the first signal and the second signal.

In some examples, to support determining the feedback by the reconfigurable reflective surface for the control message, the feedback determination component 1535 may be configured as or otherwise support a means for determining the feedback by identifying that a first value of the first channel estimate has a same sign as a second value of the second channel estimate.

In some examples, to support receiving the at least one signal reflected to the base station by the reconfigurable reflective surface from the UE, the reflected signal receiving component 1530 may be configured as or otherwise support a means for receiving a first signal indicative of the first set of phase parameters applied at the reconfigurable reflective surface for reflecting the first signal, a second signal indicative of the second set of phase parameters applied at the reconfigurable reflective surface for reflecting the second signal, or both, where the at least one signal includes the first signal, the second signal, or both.

In some examples, a first signal strength for the first signal, a second signal strength for the second signal, or both, indicate the feedback for the reconfigurable reflective surface for the control message.

In some examples, a first beam width of the first signal, a second beam width of the second signal, or both, indicate the feedback for the reconfigurable reflective surface for the control message.

In some examples, to support receiving the at least one signal reflected to the base station by the reconfigurable reflective surface from the UE, the reflected signal receiving component 1530 may be configured as or otherwise support a means for receiving the at least one signal at a first antenna panel at the base station, the at least one signal at the first antenna panel indicative of the first set of phase parameters applied at the reconfigurable reflective surface for reflecting the at least one signal. In some examples, to support receiving the at least one signal reflected to the base station by the reconfigurable reflective surface from the UE, the reflected signal receiving component 1530 may be configured as or otherwise support a means for receiving the at least one signal at a second antenna panel at the base station, the at least one signal at the second antenna panel indicative of the second set of phase parameters applied at the reconfigurable reflective surface for reflecting the at least one signal, where a code division multiple access (CDMA) pattern associated with reception of the at least one signal at the first antenna panel and reception of the at least one signal at the second antenna panel at the base station indicates the feedback for the reconfigurable reflective surface for the control message.

In some examples, the CDMA pattern includes a first energy level associated with the reception of the at least one signal at the first antenna panel and a second energy level associated with the reception of the at least one signal at the second antenna panel.

In some examples, the feedback includes an acknowledgement message indicating reception of the control message at the reconfigurable reflective surface.

In some examples, to support receiving the at least one signal reflected to the base station by the reconfigurable reflective surface from the UE, the reflected signal receiving component 1530 may be configured as or otherwise support a means for receiving a first signal indicative of the first set of phase parameters applied at the reconfigurable reflective surface for reflecting the first signal. In some examples, to support receiving the at least one signal reflected to the base station by the reconfigurable reflective surface from the UE, the reflected signal receiving component 1530 may be configured as or otherwise support a means for receiving a second signal indicative of the second set of phase parameters applied at the reconfigurable reflective surface for reflecting the second signal, where the at least one signal includes the first signal and the second signal.

In some examples, the first signal is received in a first symbol, and the second signal is received in a second symbol.

In some examples, the first symbol and the second symbol are separated by a gap.

In some examples, the control signaling component 1525 may be configured as or otherwise support a means for transmitting control signaling indicating a size of a gap between the first symbol and the second symbol, where the receiving the first signal and the second signal is based on the transmitting the control signaling.

In some examples, the first signal includes a first repetition of an uplink control channel, and the second signal includes a second repetition of the uplink control channel.

In some examples, the first set of phase parameters indicates a first bit of a bit sequence. In some examples, the second set of phase parameters indicates a second bit of the bit sequence. In some examples, the feedback includes the bit sequence.

In some examples, the at least one signal carries one or more feedback bits from the UE.

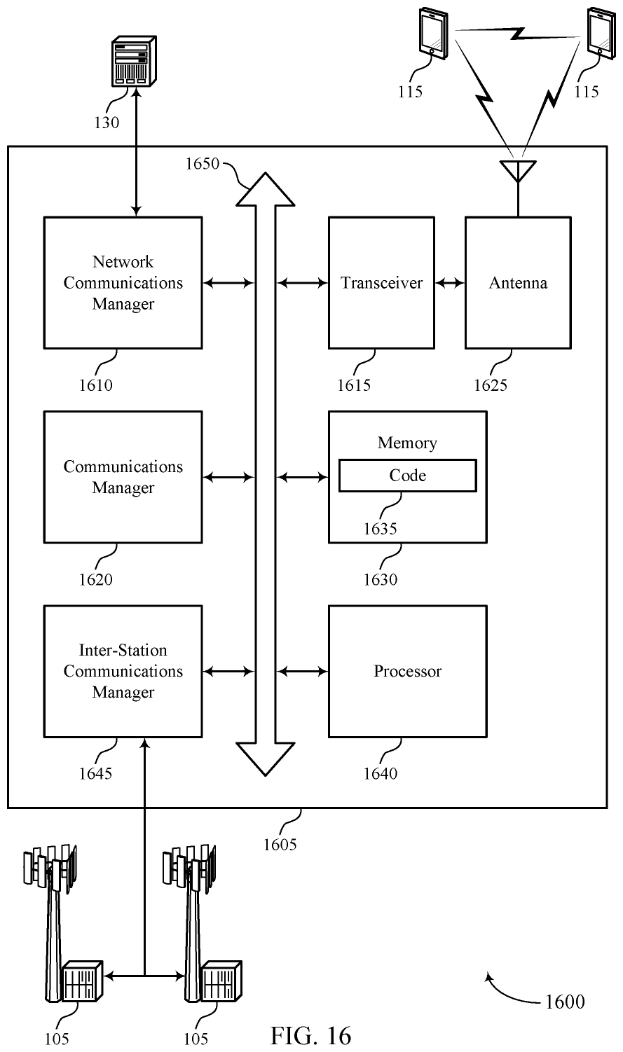

FIG. 16 shows a diagram of a system 1600 including a device 1605 that supports techniques for passive communication of a reflective surface with a base station in accordance with aspects of the present disclosure. The device 1605 may be an example of or include the components of a device 1305, a device 1405, or a base station 105 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, a network communications manager 1610, a transceiver 1615, an antenna 1625, a memory 1630, code 1635, a processor 1640, and an inter-station communications manager 1645. These components may be in electronic communication or otherwise coupled (e.g., operatively, communicatively, functionally, electronically, electrically) via one or more buses (e.g., a bus 1650).

The network communications manager 1610 may manage communications with a core network 130 (e.g., via one or more wired backhaul links). For example, the network communications manager 1610 may manage the transfer of data communications for client devices, such as one or more UEs 115.

In some cases, the device 1605 may include a single antenna 1625. However, in some other cases the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a BIOS which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting techniques for passive communication of a reflective surface with a base station). For example, the device 1605 or a component of the device 1605 may include a processor 1640 and memory 1630 coupled to the processor 1640, the processor 1640 and memory 1630 configured to perform various functions described herein.

The inter-station communications manager 1645 may manage communications with other base stations 105, and may include a controller or scheduler for controlling communications with UEs 115 in cooperation with other base stations 105. For example, the inter-station communications manager 1645 may coordinate scheduling for transmissions to UEs 115 for various interference mitigation techniques such as beamforming or joint transmission. In some examples, the inter-station communications manager 1645 may provide an X2 interface within an LTE/LTE-A wireless communications network technology to provide communication between base stations 105.

The communications manager 1620 may support wireless communications at a base station in accordance with examples as disclosed herein. For example, the communications manager 1620 may be configured as or otherwise support a means for transmitting a control message directed to a reconfigurable reflective surface. The communications manager 1620 may be configured as or otherwise support a means for receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal. The communications manager 1620 may be configured as or otherwise support a means for determining a feedback by the reconfigurable reflective surface for the control message based on the at least one signal being reflected at the reconfigurable reflective surface using at least one of the first set of phase parameters or the second set of phase parameters.

By including or configuring the communications manager 1620 in accordance with examples as described herein, the device 1605 may support techniques for improved communication reliability, reduced latency, reduced power consumption, more efficient utilization of communication resources, and improved coordination between devices.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of techniques for passive communication of a reflective surface with a base station as described herein, or the processor 1640 and the memory 1630 may be otherwise configured to perform or support such operations.

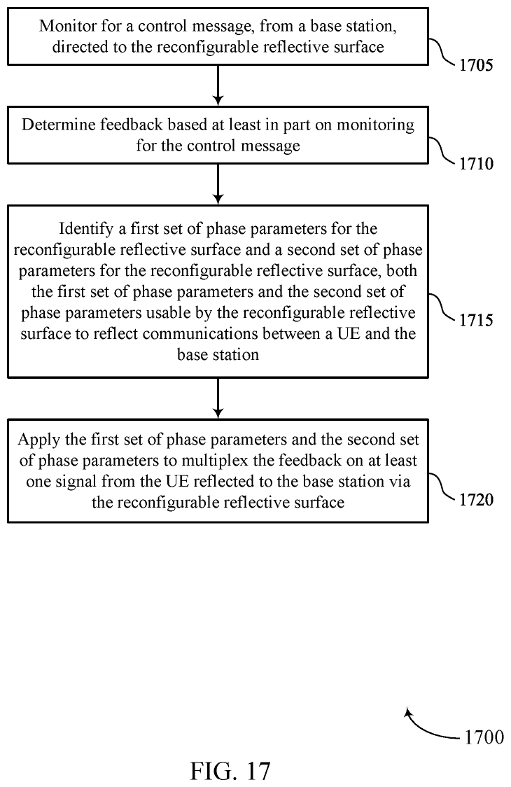

FIG. 17 shows a flowchart illustrating a method 1700 that supports techniques for passive communication of a reflective surface with a base station in accordance with aspects of the present disclosure. The operations of the method 1700 may be implemented by a reflective surface or its components as described herein. For example, the operations of the method 1700 may be performed by a reflective surface (e.g., a RIS 205) as described with reference to FIGS. 1 through 3, 4A, 4B, 5A, 5B, 6, 7A, 7B, and 8 through 12. In some examples, a reflective surface may execute a set of instructions to control the functional elements of the reflective surface to perform the described functions. Additionally or alternatively, the reflective surface may perform aspects of the described functions using special-purpose hardware.

At 1705, the method may include monitoring for a control message, from a base station, directed to the reconfigurable reflective surface. The operations of 1705 may be performed in accordance with examples as disclosed herein. In some examples, aspects of the operations of 1705 may be performed by a control signaling manager 1125 as described with reference to FIG. 11.

At 1710, the method may include determining feedback based on monitoring for the control message. The operations of 1710 may be performed in accordance with examples as disclosed herein. In some examples, aspects of the operations of 1710 may be performed by a feedback determination manager 1130 as described with reference to FIG. 11.

At 1715, the method may include identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station. The operations of 1715 may be performed in accordance with examples as disclosed herein. In some examples, aspects of the operations of 1715 may be performed by a parameter identification manager 1135 as described with reference to FIG. 11.

At 1720, the method may include applying the first set of phase parameters and the second set of phase parameters to multiplex the feedback on at least one signal from the UE reflected to the base station via the reconfigurable reflective surface. The operations of 1720 may be performed in accordance with examples as disclosed herein. In some examples, aspects of the operations of 1720 may be performed by a parameter application manager 1140 as described with reference to FIG. 11.

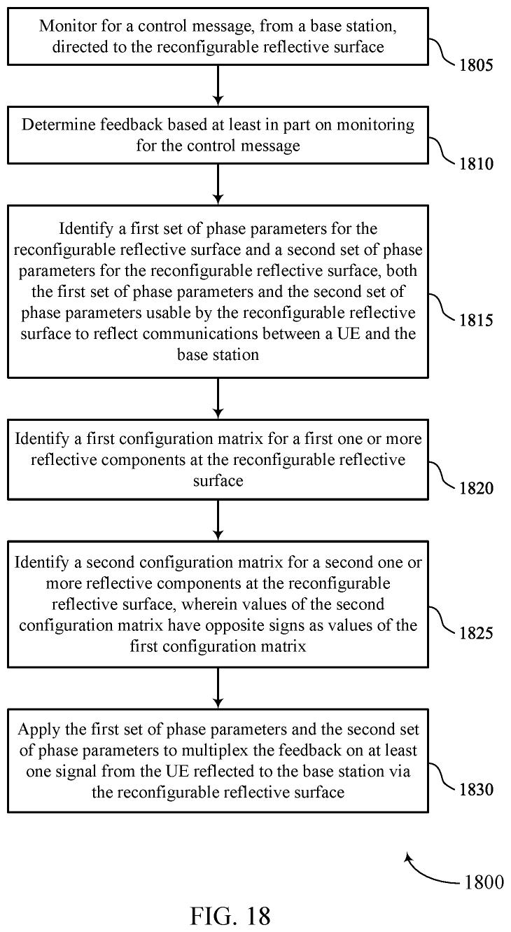

FIG. 18 shows a flowchart illustrating a method 1800 that supports techniques for passive communication of a reflective surface with a base station in accordance with aspects of the present disclosure. The operations of the method 1800 may be implemented by a reflective surface or its components as described herein. For example, the operations of the method 1800 may be performed by a reflective surface (e.g., a RIS 205) as described with reference to FIGS. 1 through 3, 4A, 4B, 5A, 5B, 6, 7A, 7B, and 8 through 12. In some examples, a reflective surface may execute a set of instructions to control the functional elements of the reflective surface to perform the described functions. Additionally or alternatively, the reflective surface may perform aspects of the described functions using special-purpose hardware.

At 1805, the method may include monitoring for a control message, from a base station, directed to the reconfigurable reflective surface. The operations of 1805 may be performed in accordance with examples as disclosed herein. In some examples, aspects of the operations of 1805 may be performed by a control signaling manager 1125 as described with reference to FIG. 11.

At 1810, the method may include determining feedback based on monitoring for the control message. The operations of 1810 may be performed in accordance with examples as disclosed herein. In some examples, aspects of the operations of 1810 may be performed by a feedback determination manager 1130 as described with reference to FIG. 11.

At 1815, the method may include identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station. The operations of 1815 may be performed in accordance with examples as disclosed herein. In some examples, aspects of the operations of 1815 may be performed by a parameter identification manager 1135 as described with reference to FIG. 11.

At 1820, the method may include identifying a first configuration matrix for a first one or more reflective components at the reconfigurable reflective surface. The operations of 1820 may be performed in accordance with examples as disclosed herein. In some examples, aspects of the operations of 1820 may be performed by a parameter identification manager 1135 as described with reference to FIG. 11.

At 1825, the method may include identifying a second configuration matrix for a second one or more reflective components at the reconfigurable reflective surface, where values of the second configuration matrix have opposite signs as values of the first configuration matrix. The operations of 1825 may be performed in accordance with examples as disclosed herein. In some examples, aspects of the operations of 1825 may be performed by a parameter identification manager 1135 as described with reference to FIG. 11.

At 1830, the method may include applying the first set of phase parameters and the second set of phase parameters to multiplex the feedback on at least one signal from the UE reflected to the base station via the reconfigurable reflective surface. The operations of 1830 may be performed in accordance with examples as disclosed herein. In some examples, aspects of the operations of 1830 may be performed by a parameter application manager 1140 as described with reference to FIG. 11.

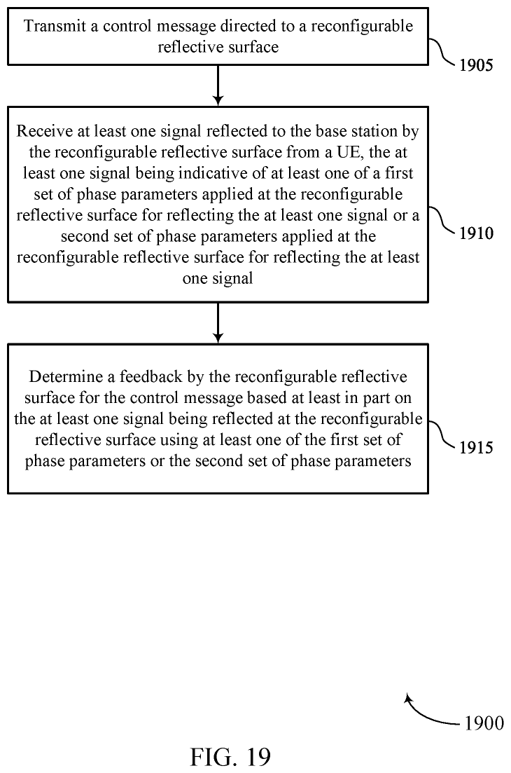

FIG. 19 shows a flowchart illustrating a method 1900 that supports techniques for passive communication of a reflective surface with a base station in accordance with aspects of the present disclosure. The operations of the method 1900 may be implemented by a base station or its components as described herein. For example, the operations of the method 1900 may be performed by a base station 105 as described with reference to FIGS. 1 through 3, 4A, 4B, 5A, 5B, 6, 7A, 7B, 8, and 13 through 16. In some examples, a base station may execute a set of instructions to control the functional elements of the base station to perform the described functions. Additionally or alternatively, the base station may perform aspects of the described functions using special-purpose hardware.

At 1905, the method may include transmitting a control message directed to a reconfigurable reflective surface. The operations of 1905 may be performed in accordance with examples as disclosed herein. In some examples, aspects of the operations of 1905 may be performed by a control signaling component 1525 as described with reference to FIG. 15.

At 1910, the method may include receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal. The operations of 1910 may be performed in accordance with examples as disclosed herein. In some examples, aspects of the operations of 1910 may be performed by a reflected signal receiving component 1530 as described with reference to FIG. 15.

At 1915, the method may include determining a feedback by the reconfigurable reflective surface for the control message based on the at least one signal being reflected at the reconfigurable reflective surface using at least one of the first set of phase parameters or the second set of phase parameters. The operations of 1915 may be performed in accordance with examples as disclosed herein. In some examples, aspects of the operations of 1915 may be performed by a feedback determination component 1535 as described with reference to FIG. 15.

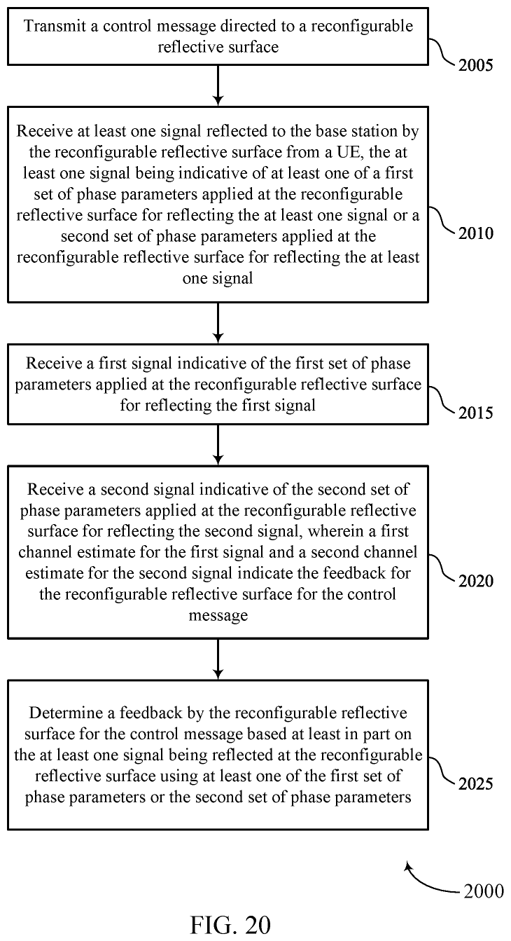

FIG. 20 shows a flowchart illustrating a method 2000 that supports techniques for passive communication of a reflective surface with a base station in accordance with aspects of the present disclosure. The operations of the method 2000 may be implemented by a base station or its components as described herein. For example, the operations of the method 2000 may be performed by a base station 105 as described with reference to FIGS. 1 through 3, 4A, 4B, 5A, 5B, 6, 7A, 7B, 8, and 13 through 16. In some examples, a base station may execute a set of instructions to control the functional elements of the base station to perform the described functions. Additionally or alternatively, the base station may perform aspects of the described functions using special-purpose hardware.

At 2005, the method may include transmitting a control message directed to a reconfigurable reflective surface. The operations of 2005 may be performed in accordance with examples as disclosed herein. In some examples, aspects of the operations of 2005 may be performed by a control signaling component 1525 as described with reference to FIG. 15.

At 2010, the method may include receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal. The operations of 2010 may be performed in accordance with examples as disclosed herein. In some examples, aspects of the operations of 2010 may be performed by a reflected signal receiving component 1530 as described with reference to FIG. 15.

At 2015, the method may include receiving a first signal indicative of the first set of phase parameters applied at the reconfigurable reflective surface for reflecting the first signal. The operations of 2015 may be performed in accordance with examples as disclosed herein. In some examples, aspects of the operations of 2015 may be performed by a reflected signal receiving component 1530 as described with reference to FIG. 15.

At 2020, the method may include receiving a second signal indicative of the second set of phase parameters applied at the reconfigurable reflective surface for reflecting the second signal, where a first channel estimate for the first signal and a second channel estimate for the second signal indicate the feedback for the reconfigurable reflective surface for the control message. The operations of 2020 may be performed in accordance with examples as disclosed herein. In some examples, aspects of the operations of 2020 may be performed by a reflected signal receiving component 1530 as described with reference to FIG. 15.

At 2025, the method may include determining a feedback by the reconfigurable reflective surface for the control message based on the at least one signal being reflected at the reconfigurable reflective surface using at least one of the first set of phase parameters or the second set of phase parameters. The operations of 2025 may be performed in accordance with examples as disclosed herein. In some examples, aspects of the operations of 2025 may be performed by a feedback determination component 1535 as described with reference to FIG. 15.

The following provides an overview of aspects of the present disclosure:

Aspect 1: A method for wireless communications at a reconfigurable reflective surface, comprising: monitoring for a control message, from a base station, directed to the reconfigurable reflective surface; determining feedback based at least in part on monitoring for the control message; identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a UE and the base station; and applying the first set of phase parameters and the second set of phase parameters to multiplex the feedback on at least one signal from the UE reflected to the base station via the reconfigurable reflective surface.

Aspect 2: The method of aspect 1, wherein identifying the first set of phase parameters for the reconfigurable reflective surface and the second set of phase parameters for the reconfigurable reflective surface comprises: identifying a first configuration matrix for a first one or more reflective components at the reconfigurable reflective surface; and identifying a second configuration matrix for a second one or more reflective components at the reconfigurable reflective surface, wherein values of the second configuration matrix have opposite signs as values of the first configuration matrix.

Aspect 3: The method of aspect 2, further comprising: multiplexing the feedback onto a combination of a first signal and a second signal from the UE by reflecting the first signal using the first set of phase parameters in accordance with the first configuration matrix and reflecting the second signal using the second set of phase parameters in accordance with the second configuration matrix, wherein the at least one signal comprises the first signal and the second signal.

Aspect 4: The method of any of aspects 2 through 3, further comprising: multiplexing the feedback onto a combination of a first signal and a second signal from the UE by reflecting the first signal using the first set of phase parameters in accordance with the first configuration matrix and reflecting the second signal using the second set of phase parameters in accordance with the first configuration matrix, wherein the at least one signal comprises the first signal and the second signal.

Aspect 5: The method of any of aspects 1 through 4, wherein identifying the first set of phase parameters for the reconfigurable reflective surface and the second set of phase parameters for the reconfigurable reflective surface comprises: identifying a first configuration matrix for a first one or more reflective components at the reconfigurable reflective surface; and identifying a second configuration matrix for a second one or more reflective components at the reconfigurable reflective surface, wherein values of the second configuration matrix weaken signal reception at the base station with respect to values of the first configuration matrix.

Aspect 6: The method of aspect 5, further comprising: multiplexing the feedback onto a first signal from the UE, a second signal from the UE, or both, by reflecting the first signal using the first set of phase parameters in accordance with the first configuration matrix, reflecting the second signal using the second set of phase parameters in accordance with the second configuration matrix, or both, wherein the at least one signal comprises the first signal, the second signal, or both.

Aspect 7: The method of any of aspects 5 through 6, wherein the values of the second configuration matrix are orthogonal to the values of the first configuration matrix.

Aspect 8: The method of any of aspects 5 through 7, wherein the values of the second configuration matrix scatter a second signal with respect to application of the values of the first configuration matrix to a first signal.

Aspect 9: The method of any of aspects 5 through 8, wherein the values of the second configuration matrix produce a wider beam than the values of the first configuration matrix.

Aspect 10: The method of any of aspects 5 through 9, wherein applying the first set of phase parameters and the second set of phase parameters comprises: deactivating the second one or more reflective components, wherein the signal reception at the base station is weakened based at least in part on deactivating the second one or more reflective components.

Aspect 11: The method of any of aspects 1 through 10, wherein identifying the first set of phase parameters for the reconfigurable reflective surface and the second set of phase parameters for the reconfigurable reflective surface comprises: identifying a first configuration matrix for a first one or more reflective components at the reconfigurable reflective surface; and identifying a second configuration matrix for a second one or more reflective components at the reconfigurable reflective surface, wherein values of the first configuration matrix and the second configuration matrix are based at least in part on a code division multiple access (CDMA) pattern associated with a first antenna panel and a second antenna panel at the base station.

Aspect 12: The method of aspect 11, further comprising: multiplexing the feedback onto the at least one signal from the UE by reflecting the at least one signal to the first antenna panel using the first set of phase parameters in accordance with the first configuration matrix and reflecting the at least one signal to the second antenna panel using the second set of phase parameters in accordance with the second configuration matrix, wherein the CDMA pattern comprises a first energy level associated with reception of the at least one signal at the first antenna panel and a second energy level associated with reception of the at least one signal at the second antenna panel.

Aspect 13: The method of any of aspects 1 through 12, further comprising: receiving the control message based at least in part on the monitoring for the control message, wherein the feedback comprises an acknowledgement message based at least in part on the receiving the control message.

Aspect 14: The method of any of aspects 1 through 13, wherein applying the first set of phase parameters and the second set of phase parameters comprises: applying a first configuration matrix for a first one or more reflective components at the reconfigurable reflective surface to reflect a first signal from the UE to the base station in accordance with the first set of phase parameters; and applying a second configuration matrix for a second one or more reflective components at the reconfigurable reflective surface to reflect a second signal from the UE to the base station in accordance with the second set of phase parameters, wherein the at least one signal comprises both the first signal and the second signal.

Aspect 15: The method of aspect 14, wherein the first signal is received from the UE in a first symbol, and the second signal is received from the UE in a second symbol.

Aspect 16: The method of aspect 15, wherein the first symbol and the second symbol are separated by a time gap.

Aspect 17: The method of any of aspects 15 through 16, further comprising: receiving control signaling indicating a size of a time gap between the first symbol and the second symbol, wherein applying the first set of phase parameters and the second set of phase parameters is based at least in part on receiving the control signaling.

Aspect 18: The method of any of aspects 14 through 17, wherein the first signal comprises a first repetition of an uplink control channel, and the second signal comprises a second repetition of the uplink control channel.

Aspect 19: The method of any of aspects 1 through 18, wherein the first set of phase parameters indicates a first bit of a bit sequence; the second set of phase parameters indicates a second bit of the bit sequence; and the feedback comprises the bit sequence.

Aspect 20: The method of any of aspects 1 through 19, wherein the at least one signal carries one or more feedback bits from the UE.

Aspect 21: A method for wireless communications at a base station, comprising: transmitting a control message directed to a reconfigurable reflective surface; receiving at least one signal reflected to the base station by the reconfigurable reflective surface from a UE, the at least one signal being indicative of at least one of a first set of phase parameters applied at the reconfigurable reflective surface for reflecting the at least one signal or a second set of phase parameters applied at the reconfigurable reflective surface for reflecting the at least one signal; and determining a feedback by the reconfigurable reflective surface for the control message based at least in part on the at least one signal being reflected at the reconfigurable reflective surface using at least one of the first set of phase parameters or the second set of phase parameters.

Aspect 22: The method of aspect 21, wherein receiving the at least one signal reflected to the base station by the reconfigurable reflective surface from the UE comprises: receiving a first signal indicative of the first set of phase parameters applied at the reconfigurable reflective surface for reflecting the first signal; receiving a second signal indicative of the second set of phase parameters applied at the reconfigurable reflective surface for reflecting the second signal, wherein a first channel estimate for the first signal and a second channel estimate for the second signal indicate the feedback for the reconfigurable reflective surface for the control message.

Aspect 23: The method of aspect 22, wherein determining the feedback by the reconfigurable reflective surface for the control message comprises: determining the feedback by identifying that a first value of the first channel estimate has an opposite sign as a second value of the second channel estimate, wherein the at least one signal comprises the first signal and the second signal.

Aspect 24: The method of any of aspects 22 through 23, wherein determining the feedback by the reconfigurable reflective surface for the control message comprises: determining the feedback by identifying that a first value of the first channel estimate has a same sign as a second value of the second channel estimate.

Aspect 25: The method of any of aspects 21 through 24, wherein receiving the at least one signal reflected to the base station by the reconfigurable reflective surface from the UE comprises: receiving a first signal indicative of the first set of phase parameters applied at the reconfigurable reflective surface for reflecting the first signal, a second signal indicative of the second set of phase parameters applied at the reconfigurable reflective surface for reflecting the second signal, or both, wherein the at least one signal comprises the first signal, the second signal, or both.

Aspect 26: The method of aspect 25, wherein a first signal strength for the first signal, a second signal strength for the second signal, or both, indicate the feedback for the reconfigurable reflective surface for the control message.

Aspect 27: The method of any of aspects 25 through 26, wherein a first beam width of the first signal, a second beam width of the second signal, or both, indicate the feedback for the reconfigurable reflective surface for the control message.

Aspect 28: The method of any of aspects 21 through 27, wherein receiving the at least one signal reflected to the base station by the reconfigurable reflective surface from the UE comprises: receiving the at least one signal at a first antenna panel at the base station, the at least one signal at the first antenna panel indicative of the first set of phase parameters applied at the reconfigurable reflective surface for reflecting the at least one signal; receiving the at least one signal at a second antenna panel at the base station, the at least one signal at the second antenna panel indicative of the second set of phase parameters applied at the reconfigurable reflective surface for reflecting the at least one signal, wherein a code division multiple access (CDMA) pattern associated with reception of the at least one signal at the first antenna panel and reception of the at least one signal at the second antenna panel at the base station indicates the feedback for the reconfigurable reflective surface for the control message.

Aspect 29: The method of aspect 28, wherein the CDMA pattern comprises a first energy level associated with the reception of the at least one signal at the first antenna panel and a second energy level associated with the reception of the at least one signal at the second antenna panel.

Aspect 30: The method of any of aspects 21 through 29, wherein the feedback comprises an acknowledgement message indicating reception of the control message at the reconfigurable reflective surface.

Aspect 31: The method of any of aspects 21 through 30, wherein receiving the at least one signal reflected to the base station by the reconfigurable reflective surface from the UE comprises: receiving a first signal indicative of the first set of phase parameters applied at the reconfigurable reflective surface for reflecting the first signal; receiving a second signal indicative of the second set of phase parameters applied at the reconfigurable reflective surface for reflecting the second signal, wherein the at least one signal comprises the first signal and the second signal.

Aspect 32: The method of aspect 31, wherein the first signal is received in a first symbol, and the second signal is received in a second symbol.

Aspect 33: The method of aspect 32, wherein the first symbol and the second symbol are separated by a time gap.

Aspect 34: The method of any of aspects 32 through 33, further comprising: transmitting control signaling indicating a size of a time gap between the first symbol and the second symbol, wherein the receiving the first signal and the second signal is based at least in part on the transmitting the control signaling.

Aspect 35: The method of any of aspects 32 through 34, wherein the first signal comprises a first repetition of an uplink control channel, and the second signal comprises a second repetition of the uplink control channel.

Aspect 36: The method of any of aspects 21 through 35, wherein the first set of phase parameters indicates a first bit of a bit sequence; the second set of phase parameters indicates a second bit of the bit sequence; and the feedback comprises the bit sequence.

Aspect 37: The method of any of aspects 21 through 36, wherein the at least one signal carries one or more feedback bits from the UE.

Aspect 38: An apparatus for wireless communications at a reconfigurable reflective surface, comprising a processor; memory coupled with the processor; and instructions stored in the memory and executable by the processor to cause the apparatus to perform a method of any of aspects 1 through 20.

Aspect 39: An apparatus for wireless communications at a reconfigurable reflective surface, comprising at least one means for performing a method of any of aspects 1 through 20.

Aspect 40: A non-transitory computer-readable medium storing code for wireless communications at a reconfigurable reflective surface, the code comprising instructions executable by a processor to perform a method of any of aspects 1 through 20.

Aspect 41: An apparatus for wireless communications at a base station, comprising a processor; memory coupled with the processor; and instructions stored in the memory and executable by the processor to cause the apparatus to perform a method of any of aspects 21 through 37.

Aspect 42: An apparatus for wireless communications at a base station, comprising at least one means for performing a method of any of aspects 21 through 37.

Aspect 43: A non-transitory computer-readable medium storing code for wireless communications at a base station, the code comprising instructions executable by a processor to perform a method of any of aspects 21 through 37.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a reconfigurable reflective surface, comprising:
monitoring for a control message, from a base station, directed to the reconfigurable reflective surface;
determining feedback based at least in part on monitoring for the control message;
identifying a first set of phase parameters for the reconfigurable reflective surface and a second set of phase parameters for the reconfigurable reflective surface, both the first set of phase parameters and the second set of phase parameters usable by the reconfigurable reflective surface to reflect communications between a user equipment (UE) and the base station; and
applying the first set of phase parameters and the second set of phase parameters to multiplex the feedback on at least one signal from the UE reflected to the base station via the reconfigurable reflective surface.

2. The method of claim 1, wherein identifying the first set of phase parameters for the reconfigurable reflective surface and the second set of phase parameters for the reconfigurable reflective surface comprises:
identifying a first configuration matrix for a first one or more reflective components at the reconfigurable reflective surface; and
identifying a second configuration matrix for a second one or more reflective components at the reconfigurable reflective surface, wherein values of the second configuration matrix have opposite signs as values of the first configuration matrix.

3. The method of claim 2, further comprising:
multiplexing the feedback onto a combination of a first signal and a second signal from the UE by reflecting the first signal using the first set of phase parameters in accordance with the first configuration matrix and reflecting the second signal using the second set of phase parameters in accordance with the second configuration matrix, wherein the at least one signal comprises the first signal and the second signal.

4. The method of claim 2, further comprising:
multiplexing the feedback onto a combination of a first signal and a second signal from the UE by reflecting the first signal using the first set of phase parameters in accordance with the first configuration matrix and reflecting the second signal using the second set of phase parameters in accordance with the first configuration matrix, wherein the at least one signal comprises the first signal and the second signal.

5. The method of claim 1, wherein identifying the first set of phase parameters for the reconfigurable reflective surface and the second set of phase parameters for the reconfigurable reflective surface comprises:
identifying a first configuration matrix for a first one or more reflective components at the reconfigurable reflective surface; and
identifying a second configuration matrix for a second one or more reflective components at the reconfigurable reflective surface, wherein values of the second configuration matrix weaken signal reception at the base station with respect to values of the first configuration matrix.

6. The method of claim 5, further comprising:
multiplexing the feedback onto a first signal from the UE, a second signal from the UE, or both, by reflecting the first signal using the first set of phase parameters in accordance with the first configuration matrix, reflecting the second signal using the second set of phase parameters in accordance with the second configuration matrix, or both, wherein the at least one signal comprises the first signal, the second signal, or both.

7. The method of claim 5, wherein the values of the second configuration matrix are orthogonal to the values of the first configuration matrix.

8. The method of claim 5, wherein the values of the second configuration matrix scatter a second signal with respect to application of the values of the first configuration matrix to a first signal.

9. The method of claim 5, wherein the values of the second configuration matrix produce a wider beam than the values of the first configuration matrix.

10. The method of claim 5, wherein applying the first set of phase parameters and the second set of phase parameters comprises:
deactivating the second one or more reflective components, wherein the signal reception at the base station is weakened based at least in part on deactivating the second one or more reflective components.

11. The method of claim 1, wherein identifying the first set of phase parameters for the reconfigurable reflective surface and the second set of phase parameters for the reconfigurable reflective surface comprises:
identifying a first configuration matrix for a first one or more reflective components at the reconfigurable reflective surface; and
identifying a second configuration matrix for a second one or more reflective components at the reconfigurable reflective surface, wherein values of the first configuration matrix and the second configuration matrix are based at least in part on a code division multiple access (CDMA) pattern associated with a first antenna panel and a second antenna panel at the base station.

12. The method of claim 11, further comprising:
multiplexing the feedback onto the at least one signal from the UE by reflecting the at least one signal to the first antenna panel using the first set of phase parameters in accordance with the first configuration matrix and reflecting the at least one signal to the second antenna panel using the second set of phase parameters in accordance with the second configuration matrix, wherein the CDMA pattern comprises a first energy level associated with reception of the at least one signal at the first antenna panel and a second energy level associated with reception of the at least one signal at the second antenna panel.

13. The method of claim 1, further comprising:
receiving the control message based at least in part on the monitoring for the control message, wherein the feedback comprises an acknowledgement message based at least in part on the receiving the control message.

14. The method of claim 1, wherein applying the first set of phase parameters and the second set of phase parameters comprises:
applying a first configuration matrix for a first one or more reflective components at the reconfigurable reflective surface to reflect a first signal from the UE to the base station in accordance with the first set of phase parameters; and
applying a second configuration matrix for a second one or more reflective components at the reconfigurable reflective surface to reflect a second signal from the UE to the base station in accordance with the second set of phase parameters, wherein the at least one signal comprises both the first signal and the second signal.

15. The method of claim 14, wherein the first signal comprises a first repetition of an uplink control channel, and the second signal comprises a second repetition of the uplink control channel.

16. The method of claim 1, wherein:
the first set of phase parameters indicates a first bit of a bit sequence;
the second set of phase parameters indicates a second bit of the bit sequence; and
the feedback comprises the bit sequence.

17. A method for wireless communications at a base station, comprising:
transmitting a control message directed to a reconfigurable reflective surface;
receiving at least one signal reflected to the base station by the reconfigurable reflective surface from a user equipment (UE), the at least one signal being indicative of at least one of a first set of phase parameters applied at the reconfigurable reflective surface for reflecting the at least one signal or a second set of phase parameters applied at the reconfigurable reflective surface for reflecting the at least one signal; and
determining a feedback by the reconfigurable reflective surface for the control message based at least in part on the at least one signal being reflected at the reconfigurable reflective surface using at least one of the first set of phase parameters or the second set of phase parameters.

18. The method of claim 17, wherein receiving the at least one signal reflected to the base station by the reconfigurable reflective surface from the UE comprises:
receiving a first signal indicative of the first set of phase parameters applied at the reconfigurable reflective surface for reflecting the first signal;
receiving a second signal indicative of the second set of phase parameters applied at the reconfigurable reflective surface for reflecting the second signal, wherein a first channel estimate for the first signal and a second channel estimate for the second signal indicate the feedback for the reconfigurable reflective surface for the control message.

19. The method of claim 18, wherein determining the feedback by the reconfigurable reflective surface for the control message comprises:
determining the feedback by identifying that a first value of the first channel estimate has an opposite sign as a second value of the second channel estimate, wherein the at least one signal comprises the first signal and the second signal.

20. The method of claim 18, wherein determining the feedback by the reconfigurable reflective surface for the control message comprises:
determining the feedback by identifying that a first value of the first channel estimate has a same sign as a second value of the second channel estimate.

21. The method of claim 17, wherein receiving the at least one signal reflected to the base station by the reconfigurable reflective surface from the UE comprises:
receiving a first signal indicative of the first set of phase parameters applied at the reconfigurable reflective surface for reflecting the first signal, a second signal indicative of the second set of phase parameters applied at the reconfigurable reflective surface for reflecting the second signal, or both, wherein the at least one signal comprises the first signal, the second signal, or both.

22. The method of claim 21, wherein a first signal strength for the first signal, a second signal strength for the second signal, or both, indicate the feedback for the reconfigurable reflective surface for the control message.

23. The method of claim 21, wherein a first beam width of the first signal, a second beam width of the second signal, or both, indicate the feedback for the reconfigurable reflective surface for the control message.

24. The method of claim 17, wherein receiving the at least one signal reflected to the base station by the reconfigurable reflective surface from the UE comprises:
receiving the at least one signal at a first antenna panel at the base station, the at least one signal at the first antenna panel indicative of the first set of phase parameters applied at the reconfigurable reflective surface for reflecting the at least one signal;
receiving the at least one signal at a second antenna panel at the base station, the at least one signal at the second antenna panel indicative of the second set of phase parameters applied at the reconfigurable reflective surface for reflecting the at least one signal, wherein a code division multiple access (CDMA) pattern associated with reception of the at least one signal at the first antenna panel and reception of the at least one signal at the second antenna panel at the base station indicates the feedback for the reconfigurable reflective surface for the control message.

25. The method of claim 24, wherein the CDMA pattern comprises a first energy level associated with the reception of the at least one signal at the first antenna panel and a second energy level associated with the reception of the at least one signal at the second antenna panel.

26. The method of claim 17, wherein receiving the at least one signal reflected to the base station by the reconfigurable reflective surface from the UE comprises:
receiving a first signal indicative of the first set of phase parameters applied at the reconfigurable reflective surface for reflecting the first signal; and
receiving a second signal indicative of the second set of phase parameters applied at the reconfigurable reflective surface for reflecting the second signal, wherein the at least one signal comprises the first signal and the second signal.

27. The method of claim 26, wherein the first signal comprises a first repetition of an uplink control channel, and the second signal comprises a second repetition of the uplink control channel.

28. The method of claim 17, wherein:
the first set of phase parameters indicates a first bit of a bit sequence;
the second set of phase parameters indicates a second bit of the bit sequence; and
the feedback comprises the bit sequence.

29. An apparatus for wireless communications at a reconfigurable reflective surface, comprising:
a processor;
memory coupled with the processor; and
instructions stored in the memory and executable by the processor to cause the apparatus to:
monitor for a control message, from a base station, directed to the reconfigurable reflective surface;
determine feedback based at least in part on monitoring for the control message;
identify a first set of phase parameters for the reconfigurable reflective surface and a second set of phase parameters for the reconfigurable reflective surface, both the first set of phase parameters and the second set of phase parameters usable by the reconfigurable reflective surface to reflect communications between a user equipment (UE) and the base station; and
apply the first set of phase parameters and the second set of phase parameters to multiplex the feedback on at least one signal from the UE reflected to the base station via the reconfigurable reflective surface.

30. An apparatus for wireless communications at a base station, comprising:
a processor;
memory coupled with the processor; and
instructions stored in the memory and executable by the processor to cause the apparatus to:
transmit a control message directed to a reconfigurable reflective 7 surface;
receive at least one signal reflected to the base station by the reconfigurable reflective surface from a user equipment (UE), the at least one signal being indicative of at least one of a first set of phase parameters applied at the reconfigurable reflective surface for reflecting the at least one signal or a second set of phase parameters applied at the reconfigurable reflective surface for reflecting the at least one signal; and
determine a feedback by the reconfigurable reflective surface for the control message based at least in part on the at least one signal being reflected at the 16 reconfigurable reflective surface using at least one of the first set of phase parameters or the second set of phase parameters.
